(19) United States
(12) Patent Application Publication
(10) Pub. No.: US 2024/0203101 A1
(43) Pub. Date: Jun. 20, 2024

(54) HIERARCHICAL WORKFLOW FOR GENERATING ANNOTATED TRAINING DATA FOR MACHINE LEARNING ENABLED IMAGE SEGMENTATION

(71) Applicant: Genentech, Inc., South San Francisco, CA (US)

(72) Inventors: Miao ZHANG, South San Francisco, CA (US); Nagamurali K. MOVVA, South San Francisco, CA (US); Mahdi ABBASPOUR TEHRANI, South San Francisco, CA (US)

(21) Appl. No.: 18/536,174

(22) Filed: Dec. 11, 2023

Related U.S. Application Data
(63) Continuation of application No. PCT/US2022/033068, filed on Jun. 10, 2022.
(60) Provisional application No. 63/209,839, filed on Jun. 11, 2021.

(51) Int. Cl. G06V 10/774; G06T 7/00; G06V 10/82

(52) U.S. Cl. CPC G06V 10/774; G06T 7/0012; G06V 10/82; G06T 2207/20104; G06T 2207/30041; G06V 2201/03

(57) ABSTRACT

Systems and methods for annotating medical images using an artificial intelligence (AI)-enabled workflow are disclosed herein. In some example embodiments, an image of a sample may be labeled using an annotation generated by a neural network The annotation may represent a feature in the image. In some instances, the labeled image may be reviewed by laypersons and/or experts for accuracy and/or completeness, and the labeled image may be updated based on the review to generate an annotated image.

### CROSS-REFERENCE TO RELATED APPLICATIONS

The present application is a continuation of International Application No. PCT/US2022/033068, filed on Jun. 10, 2022, which claims priority to U.S. Provisional Application No. 63/209,839, entitled “SYSTEMS AND METHODS FOR ANNOTATING MEDICAL IMAGES USING AN ARTIFICIAL INTELLIGENCE (AI)-ENABLED HIERARCHICAL WORKFLOW” and filed on Jun. 11, 2022, the disclosures of which are incorporated herein by reference in their entirety.

### FIELD

The present disclosure generally relates to machine learning and more specifically generating annotated training data for machine learning enabled image segmentation.

### INTRODUCTION

Artificial intelligence (AI) has been instrumental in revolutionizing healthcare including by allowing healthcare providers to exploit big data in the diagnosis, progression monitoring, and treatment of patients for a variety of disease and conditions. Examples of big data include medical images of various imaging modalities. The medical images may be subjected to analysis by various types of machine learning models to identify features that aid in the diagnoses, progression monitoring, and treatment of patients. However, generating training data for such machine learning models, which includes annotating medical images with ground truth labels, can be a cumbersome and expensive task at least because subject matter experts are typically required for annotating the medical images. Further, the manual annotation process of using subject matter experts to generate annotations may be unreliable, as experts may vary in their training, conventions used, standards, eyesight, or propensity for human error.

### SUMMARY

The following summarizes some embodiments of the present disclosure to provide a basic understanding of the discussed technology. This summary is not an extensive overview of all contemplated features of the disclosure and is intended neither to identify key or critical elements of all embodiments of the disclosure nor to delineate the scope of any or all embodiments of the disclosure. Its sole purpose is to present some concepts of one or more embodiments of the disclosure in summary form as a prelude to the more detailed description that is presented later.

Systems, methods, and articles of manufacture, including computer program products, are provided for generating annotated training data for machine learning enabled segmentation of medical images. In some example embodiments, there is provided a system that includes at least one processor and at least one memory. The at least one memory may include program code that provides operations when executed by the at least one processor. The operations may include: determining, based at least on a first input, a first set of labels for segmenting an image; updating, based at least on a second input, the first set of labels to generate a second set of labels for segmenting the image; generating, based at least on the first set of labels and/or the second set of labels, a set of ground truth labels for segmenting the image; generating a training sample to include the image and the set of ground truth labels for the image; and training, based at least on the training sample, a machine learning model to perform image segmentation.

In another aspect, there is provided a method for generating annotated training data for machine learning enabled segmentation of medical images. The method may include: determining, based at least on a first input, a first set of labels for segmenting an image; updating, based at least on a second input, the first set of labels to generate a second set of labels for segmenting the image; generating, based at least on the first set of labels and/or the second set of labels, a set of ground truth labels for segmenting the image; generating a training sample to include the image and the set of ground truth labels for the image; and training, based at least on the training sample, a machine learning model to perform image segmentation.

In another aspect, there is provided a computer program product including a non-transitory computer readable medium storing instructions. The instructions may cause operations may executed by at least one data processor. The operations may include: determining, based at least on a first input, a first set of labels for segmenting an image; updating, based at least on a second input, the first set of labels to generate a second set of labels for segmenting the image; generating, based at least on the first set of labels and/or the second set of labels, a set of ground truth labels for segmenting the image; generating a training sample to include the image and the set of ground truth labels for the image; and training, based at least on the training sample, a machine learning model to perform image segmentation.

In some variations of the methods, systems, and non-transitory computer readable media, one or more of the following features can optionally be included in any feasible combination. The machine learning model may be applied to generate a set of preliminary labels for segmenting the image. The set of preliminary labels to generate the first set of labels may be updated based at least on a third input.

In some variations, the first set of labels may be combined to generate an aggregated label set. A user interface including the aggregated label set may be generated for display at one or more client devices.

In some variations, a simultaneous truth and performance level estimation (STAPLE) algorithm may be applied to combine the first set of labels.

In some variations, the first set of labels may include a first label assigned to a pixel in the image by a first reviewer, a second label assigned to the pixel by a second reviewer, and a third label assigned to the pixel by a third reviewer.

In some variations, the aggregated label set may include, for the pixel in the image, a fourth label corresponding to a weighted combination of the first label, the second label, and the third label.

In some variations, the first label may be associated with a first weight corresponding to a first accuracy of the first reviewer, the second label may be associated with a second weight corresponding to a second accuracy of the second reviewer, and the third label may be associated with a third weight corresponding to a third accuracy of the third reviewer.

In some variations, the second input may confirm, refute, and/or modify the fourth label.

In some variations, a consensus metric indicative a level of discrepancy between a plurality of labels assigned to a same pixel in the image by different reviewers may be determined.

In some variations, the consensus metric may include an intersection over union (IOU).

In some variations, the first set of labels may be escalated for review upon determining that the consensus metric for the first set of labels fail to satisfy a threshold.

In some variations, the set of ground truth labels may identify one or more features present within the image.

In some variations, the set of ground truth labels may include, for each pixel within the image, a label identifying the pixel as belonging to a feature of the one or more features present within the image.

In some variations, the one or more features may include one or more structures, abnormalities, and/or morphological changes present in a retina depicted in the image.

In some variations, the one or more features may be biomarkers for a disease.

In some variations, the one or more features may be biomarkers for predicting a progression of nascent geographic atrophy (nGA) and/or age-related macular degeneration (AMD).

In some variations, the one or more features may include drusen volume, maximum drusen height, hyperreflective foci (HRF) volume, minimum outer nuclear layer (ONL) thickness, and retinal pigment epithelium (RPE) volume.

In some variations, the machine learning model may be a neural network.

In some variations, the image may be one or more of a computed tomography (CT) image, an optical coherence tomography (OCT) scan, an X-ray image, a magnetic resonance imaging (MRI) scan, and an ultrasound image.

In some variations, the first input may be associated with a first group of reviewers and the second input is associated with a second group of reviewers.

Some embodiments of the present disclosure further disclose a method comprising receiving an image of a sample having a feature. The method further comprises generating, using a neural network, an annotation representing the feature; and generating, using the neural network, a labeled image comprising the annotation. In addition, the method comprises prompting presentation of the labeled image to an image correction interface. Further, the method comprises receiving, from the image correction interface, label correction data related to the annotation generated by the first neural network; and updating the labeled image using the label correction data to generate an annotated image comprising an update to the labeled image.

Some embodiments of the present disclosure disclose a system comprising a non-transitory memory; and a hardware processor coupled with the non-transitory memory and configured to read instructions from the non-transitory memory to cause the system to perform operations. In some example embodiments, the operations comprise receiving an image of a sample having a feature. The operations further comprise generating, using a neural network, an annotation representing the feature; and generating, using the neural network, a labeled image comprising the annotation. In addition, the operations comprise prompting presentation of the labeled image to an image correction interface. Further, the operations comprise receiving, from the image correction interface, label correction data related to the annotation generated by the first neural network; and updating the labeled image using the label correction data to generate an annotated image comprising an update to the labeled image.

Some embodiments of the present disclosure disclose a non-transitory computer-readable medium (CRM) having stored thereon computer-readable instructions executable to cause a computer system to perform operations. In some example embodiments, the operations comprise receiving an image of a sample having a feature. The operations further comprise generating, using a neural network, an annotation representing the feature; and generating, using the neural network, a labeled image comprising the annotation. In addition, the operations comprise prompting presentation of the labeled image to an image correction interface. Further, the operations comprise receiving, from the image correction interface, label correction data related to the annotation generated by the first neural network; and updating the labeled image using the label correction data to generate an annotated image comprising an update to the labeled image.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including, for example, to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to machine learning enabled segmentation of medical images, it should be readily understood that such features are not intended to be limiting. The claims that follow this disclosure are intended to define the scope of the protected subject matter.

### BRIEF DESCRIPTION OF THE DRAWINGS

For a more complete understanding of the principles disclosed herein, and the advantages thereof, reference is now made to the following descriptions taken in conjunction with the accompanying drawings, in which:

FIG. 1A depicts a block diagram illustrating an example of an image annotation system in accordance with various embodiments of the present disclosure.

FIG. 1B depicts a system diagram illustrating an example of an image annotation system in accordance with various embodiments of the present disclosure.

FIG. 2A depicts a flowchart illustrating an example of a process for annotating medical images, in accordance with various embodiments of the present disclosure.

FIG. 2B depicts a flowchart illustrating an example of a hierarchical workflow for generating annotated training data for machine learning enabled segmentations of medical images in accordance with various embodiments of the present disclosure.

FIG. 2C depicts various examples of workflows for generating annotated training data for machine learning enabled segmentation of medical images in accordance with various embodiments of the present disclosure.

FIG. 3 depicts a schematic diagram illustrating an example of a neural network in accordance with various embodiments of the present disclosure.

FIG. 4A depicts a flowchart illustrating an example of a process for annotating medical images in accordance with various embodiments of the present disclosure.

FIG. 4B depicts a flowchart illustrating an example of a process for generating annotated training data for machine learning enabled segmentation of medical images in accordance with various embodiments of the present disclosure.

FIG. 5 depicts a block diagram illustrating an example of a computer system m accordance with various embodiments of the present disclosure.

FIG. 6 depicts an example of a medical image annotated with segmentation labels in accordance with various embodiments of the present disclosure.

FIG. 7A depicts a qualitative evaluation of medical image annotations in accordance with various embodiments of the present disclosure.

FIG. 7B depicts a quantitative evaluation of medical image annotations in accordance with various embodiments of the present disclosure.

FIG. 8 depicts a comparison of a raw medical image, an annotated medical image, and a segmented medical image output by a trained machine learning model in accordance with various embodiments of the present disclosure.

FIG. 9 depicts examples of biomarkers for predicting progression of nascent geographic atrophy (nGA) in accordance with various embodiments of the present disclosure.

It is to be understood that the figures are not necessarily drawn to scale, nor are the objects in the figures necessarily drawn to scale in relationship to one another. The figures are depictions that are intended to bring clarity and understanding to various embodiments of apparatuses, systems, and methods disclosed herein. Wherever possible, the same or similar reference numbers will be used throughout the drawings to refer to the same or like structures, features or elements. Moreover, it should be appreciated that the drawings are not intended to limit the scope of the present teachings in any way.

### DETAILED DESCRIPTION

Medical imaging technologies are powerful tools that can be used to produce medical images that allow healthcare practitioners to better visualize and understand the medical issues of their patients, and as such provide the same more accurate diagnoses and treatment options. Non-limiting examples of medical imaging technologies include computed tomography (CT) imaging, optical coherence tomography (OCT) imaging, X-ray imaging, magnetic resonance imaging (MRI) imaging, ultrasound imaging, and/or the like. Such imaging technologies can be used across a diverse field of medical fields. For example, computed tomography (CT) scan images or magnetic resonance imaging (MRI) images may be used to diagnose brain disorders such as tumors, brain tissue damages, etc., while ultrasound images can be cost effective means for investigating medical issues arising in organs such as livers (e.g., lesions, tumors, etc.), kidneys (e.g., kidney stones, etc.), and/or. The imaging techniques may not be limited to a particular medical field. For instance, any of the aforementioned imaging technologies may be applied for ophthalmological investigations in cases such as but not limited to age-related macular degeneration (AMD) diagnoses and treatments.

Although medical images can include valuable information about patients' health conditions, extracting the information from the medical images can be a resource-intensive and difficult task, leading to erroneous conclusions being drawn about the information contained in the medical images. For example, the medical image can be an image of a sample that has features indicative of disease or conditions, and identifying the features in the medical image can be challenging. The use of trained reviewers, in particular subject matter experts trained at reviewing medical images, to annotate medical images of samples identifying various features of the samples may improve the accuracy of the conclusions. However, the process can still be laborious, may have inherent undesirable variability between reviewers, and can be particularly costly, and may not meet the needs of health care providers for an efficient, cost-effective, and accurate mechanism to identify or extract the valuable information in the medical images for use by the health care practitioners in providing their patients appropriate diagnoses and treatments.

Artificial intelligence (AI)-based systems can be trained to identify features of a sample in a medical image thereof, and as such can be suitable as annotation tools to label the features in the medical image. One approach for training a machine learning model, such as a neural network, is a supervised learning approach where the neural network is trained using annotated training dataset in which each training sample is a medical image exhibiting certain input data attributes and associated with one or more ground truth labels of the corresponding target attributes. That is, each training sample may be a medical image that has been annotated with one or more ground truth labels of the features present within the medical image. Such features may be biomarkers that may be used for the diagnosis, progression monitoring, and treatment of a particular disease or condition. The training of the machine learning model may then include a process in which the machine learning model is adjusted to minimize the errors present in the output of the machine learning model when the machine learning model is applied to the training dataset. For example, training the machine learning model may include adjusting the weights applied by the machine learning model, such as through backpropagation of the error present in the output of the machine learning model, to minimize the discrepancy between the ground truth labels assigned to each training sample and the corresponding labels determined by the machine learning model. Through training, the machine learning model may learn the patterns present within the training dataset that allows the machine learning model to map input data attributes in a medical image (e.g., the features) to one or more target attributes (e.g., labels). The trained neural network may then be deployed, for example, in a clinical setting, to identify relevant features (e.g., biomarkers) present in the medical images of patients.

Because the performance and efficiency of a machine learning model may depend on the quality of the training dataset, the annotation of the dataset may be performed with care and, at least a part of the annotation, by subject matter experts who are qualified to perform the annotations. This, in turn, may make the process costly, variable, and laborious as discussed above with reference to expert annotations of features in medical images. Accordingly, improved techniques for generating annotated training data for machine learning enabled segmentation of medical images may be desired.

In some example embodiments, an annotation controller may be configured to implement a hierarchical workflow for generating annotated training data in which the ground truth labels assigned to a training sample are determined based on inputs from multiple groups of reviewers. For example, to generate an annotated training sample, the annotation controller may determine, based on inputs received from a first group of reviewers, a first set of labels for a medical image. The first set of labels may include one or more pixel-wise segmentation labels that assigns, to one or more pixels within the medical image, a label corresponding to an anatomical feature depicted by each pixel. In some cases, the first set of labels may be generated by updating, based on inputs from the first group of reviewers, a set of preliminary labels determined by a machine learning model, which may be a same or different machine learning model as the one subjected to subsequent training.

By way of example, the annotation controller may determine, based on an input received from at least one reviewer, a first label or a first set of labels for a medical image. The first label/set of labels may include a pixel-wise segmentation label that assigns, to a pixel within the medical image, a label corresponding to an anatomical feature depicted by the pixel. In some cases, the first label/set of labels may be generated by updating, based on an from the first reviewer, a preliminary label or a set of preliminary labels determined by a machine learning model, which may be a same or different machine learning model as the one subjected to subsequent training.

Where the medical image is an optical coherence tomography (OCT) scan, one or more pixels of the medical image may be assigned a label corresponding to retinal structures such as an inner limiting membrane (ILM), an external or outer plexiform layer (OPL), a retinal pigment epithelium (RPE), a Bruch's membrane (BM), and/or the like. In some cases, one or more pixels of the medical image may also be assigned a label corresponding to abnormalities and/or morphological changes such as the presence of a drusen, a reticular pseudodrusen (RPD), a retinal hyperreflective foci (e.g., a lesion with equal or greater reflectivity than the retinal pigment epithelium), a hyporeflective wedge-shaped structure (e.g., appearing within the boundaries of the outer plexiform layer), choroidal hypertransmission defects, and/or the like.

Upon determining that a certain level of discrepancy is present within the first set of labels, the annotation controller may determine a second set of labels for the medical image by at least updating the first set of labels based on inputs received from a second group of reviewers. In some cases, the annotation controller may determine the second set of labels when the first set of labels exhibits an above-threshold level of discrepancy as indicated, for instance, by the first set of labels having a below-threshold consensus metric (e.g., an intersection over union (IOU) and/or the like). Alternatively, the annotation controller may determine the second set of labels when a below-threshold level of discrepancy is present within the first set of labels, for example, based on an above-threshold consensus metric amongst the first set of labels.

In some example embodiments, the annotation controller may generate a user interface (e.g., a graphic user interface (GUI)) displaying an aggregate of the first set of labels associated with the medical image such that the inputs received from the second group of reviewers include corrections of the aggregate of the first set of labels. The annotation controller may determine the aggregate of the first set of labels in a variety of ways. For example, in some cases, the annotation controller may aggregate the first set of labels by applying a simultaneous truth and performance level estimation (STAPLE) algorithm, for example, to determine a probabilistic estimate of the true segmentation of the medical image by estimating an optimal combination of the individual segmentations provided by the first group of reviewers and weighing each segmentation based on the performance of the corresponding reviewer.

In some example embodiments, the annotation controller may determine, based at least on the second set of labels, one or more ground truth labels for the medical image. The medical image and the one or more ground truth labels associated with the medical image may form an annotated training sample for training a machine learning model, such as a neural network, to perform segmentation of medical images. For example, a training dataset including the annotated training sample may be used to train the machine learning model to assign, to each pixel within a medical image, a label indicating whether the pixel forms a portion of an anatomical feature depicted in the medical image. Training the machine learning model to perform image segmentation may include adjusting the machine learning model to minimize the errors present in the output of the machine learning model. For instance, the machine learning model may be trained by at least adjusting the weights applied by the machine learning model in order to minimize a quantity of incorrectly labeled pixels in the output of the machine learning model. As noted, where the medical image is an optical coherence tomography (OCT) scan of a patient, the trained machine learning model performing image segmentation on the medical image may identify a variety of features, such as retinal structures, abnormalities, and/or morphological changes in a retina depicted in the medical image. In some cases, in addition to the patient's age, at least some of the biomarkers for the predicting the progression of an eye disease in the patient, such as age-related macular degeneration (AMD) and nascent geographic atrophy (nGA), may be determined based on one or more of those features (e.g., drusen volume, maximum drusen height, hyperreflective foci (HRF) volume, minimum outer nuclear layer (ONL) thickness, retinal pigment epithelium (RPE) volume, and/or the like).

Various embodiments of the present disclosure provide systems and methods directed to a hierarchical workflow for generating annotated training data for training a machine learning model to perform segmentation of medical images. As noted, the trained machine learning model may segment a medical image by at least assigning, to each pixel within a medical image, a label identifying the pixel as belonging to a particular feature (e.g., retinal structure, abnormalities, morphological changes, and/or the like) depicted in the medical image. The hierarchical workflow may include determining one or more ground truth labels for the medical image based on a first set of labels associated with a first set of reviewers or, in the event the first set of labels exhibit an above-threshold discrepancy, a second set of labels associated with a second set of reviewers that includes one or more updates to the first set of labels. In some cases, the first set of labels may be itself be generated by updating, based on inputs from the first group of reviewers, a set of preliminary labels determined by the machine learning model. The disclosed hierarchical workflow may reduce time and resource required to generate annotated training data for the machine learning model. In some cases, after a limited number of training cycles, the machine learning model may achieve sufficient performance (e.g., classification accuracy), such as when the preliminary labels determined by the machine learning model require little or no corrections, in which case the machine learning model may be capable of annotating medical images in a clinical setting with minimal reviewer oversight and intervention.

The disclosure is not limited to these exemplary embodiments and applications or to the manner in which the exemplary embodiments and applications operate or are described herein. Moreover, the figures may show simplified or partial views, and the dimensions of elements in the figures may be exaggerated or otherwise not in proportion.

Where reference is made to a list of elements (e.g., elements a, b, c), such reference is intended to include any one of the listed elements by itself, any combination of less than all of the listed elements, and/or a combination of all of the listed elements. Section divisions in the specification are for ease of review only and do not limit any combination of elements discussed.

The term “subject” may refer to a subject of a clinical trial, a person or animal undergoing treatment, a person or animal undergoing anti-cancer therapies, a person or animal being monitored for remission or recovery, a person or animal undergoing a preventative health analysis (e.g., due to their medical history), or any other person or patient or animal of interest. In various cases, “subject” and “patient” may be used interchangeably herein.

The term “medical image” may refer to an image of a tissue, an organ, etc., that is captured using a medical imaging technology or technique including but not limited to computed tomography (CT) imaging technology, optical coherence tomography (OCT) imaging technology, X-ray imaging technology, magnetic resonance imaging (MRI) imaging technology, ultrasound imaging technology, confocal scanning laser ophthalmoscopy (cSLO) imaging technology, and/or the like. The term “medical image” may also refer to an image of a tissue, an organ, a bone, etc., that is captured using any type of camera (e.g., including cameras that may not be specifically designed for medical imaging or that may be found on personal devices such as smartphones) that can be used for medical purposes including but not limited to diagnosis, monitoring, treatment, research, clinical trials, and/or the like.

The term “sample” may refer to a tissue, an organ, a bone, etc., of an entity such as a patient or subject. As such, when referring to a medical image of a sample being taken, the term may refer to the tissue, the organ, the bone, etc., of the patient/subject the medical image of whom is captured.

Unless otherwise defined, scientific and technical terms used in connection with the present teachings described herein shall have the meanings that are commonly understood by those of ordinary skill in the art. Further, unless otherwise required by context, singular terms shall include pluralities and plural terms shall include the singular. Generally, nomenclatures utilized in connection with, and techniques of, chemistry, biochemistry, molecular biology, pharmacology and toxicology are described herein are those well-known and commonly used in the art.

As used herein, “substantially” means sufficient to work for the intended purpose. The term “substantially” thus allows for minor, insignificant variations from an absolute or perfect state, dimension, measurement, result, or the like such as would be expected by a person of ordinary skill in the field but that do not appreciably affect overall performance. When used with respect to numerical values or parameters or characteristics that can be expressed as numerical values, “substantially” means within ten percent.

As used herein, the term “about” used with respect to numerical values or parameters or characteristics that can be expressed as numerical values means within ten percent of the numerical values. For example, “about 50” means a value in the range from 45 to 55, inclusive.

The term “ones” means more than one.

As used herein, the term “plurality” can be 2, 3, 4, 5, 6, 7, 8, 9, 10, or more.

As used herein, the term “set of” means one or more. For example, a set of items includes one or more items.

As used herein, the phrase “at least one of,” when used with a list of items, means different combinations of one or more of the listed items may be used and only one of the items in the list may be needed. The item may be a particular object, thing, step, operation, process, or category. In other words, “at least one of” means any combination of items or number of items may be used from the list, but not all of the items in the list may be required. For example, without limitation, “at least one of item A, item B, or item C” means item A; item A and item B; item B; item A, item B, and item C; item B and item C; or item A and C. In some cases, “at least one of item A, item B, or item C” means, but is not limited to, two of item A, one of item B, and ten of item C; four of item B and seven of item C; or some other suitable combination.

As used herein, a “model” may include one or more algorithms, one or more mathematical techniques, one or more machine learning (ML) algorithms, or a combination thereof.

As used herein, “machine learning” may include the practice of using algorithms to parse data, learn from it, and then make a determination or prediction about something in the world. Machine learning uses algorithms that can learn from data without relying on rules-based programming.

As used herein, an “artificial neural network” or “neural network” (NN) may refer to mathematical algorithms or computational models that mimic an interconnected group of artificial neurons that processes information based on a connectionistic approach to computation. Neural networks, which may also be referred to as neural nets, can employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters. In the various embodiments, a reference to a “neural network” may be a reference to one or more neural networks.

A neural network may process information in two ways; when it is being trained it is in training mode and when it puts what it has learned into practice it is in inference (or prediction) mode. Neural networks may learn through a feedback process (e.g., backpropagation) which allows the network to adjust the weight factors (modifying its behavior) of the individual nodes in the intermediate hidden layers so that the output matches the outputs of the training data. In other words, a neural network may learn by being fed training data (learning examples) and eventually learns how to reach the correct output, even when it is presented with a new range or set of inputs.

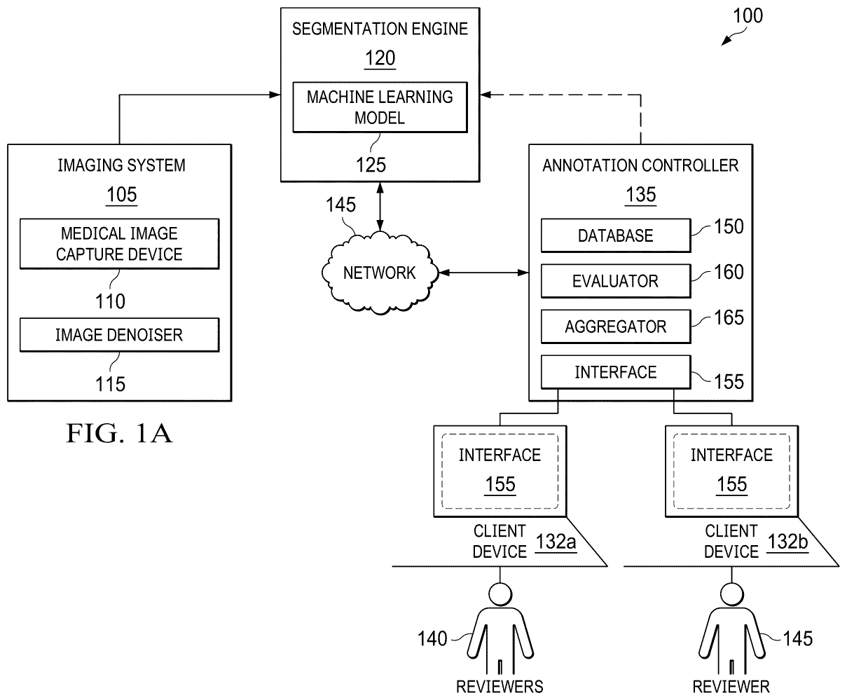

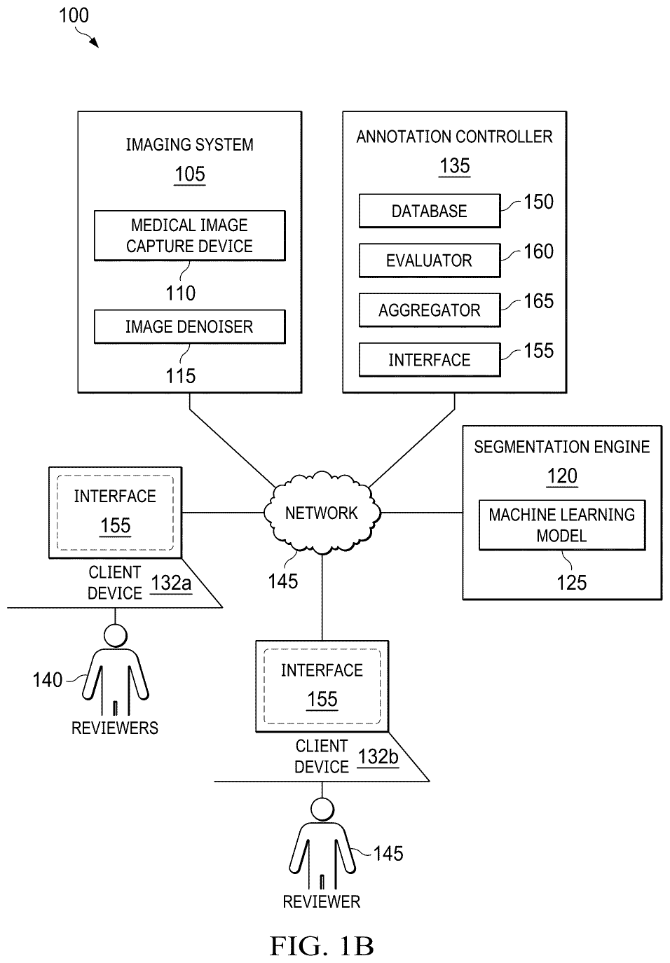

FIGS. 1A-1B depict an example of an image annotation system 100 in accordance with various embodiments of the present disclosure. The image annotation system 100 may include or implement a plurality of servers and/or software components that operate to perform various processes related to the capturing of a medical image of a sample, the processing of said captured medical image, the generation of annotations to label features of the samples on the medical image, the inputting of label correction data including label correction feedback into a system interface, etc. Exemplary servers may include, for example, stand-alone and enterprise-class servers operating a server operating system such as a MICROSOFT™ OS, a UNIX™ OS, a LINUX™ OS, or other suitable server-based operating systems. It can be appreciated that the servers illustrated in FIGS. 1A-B may be deployed in other ways and that the operations performed and/or the services provided by such servers may be combined or separated for a given implementation and may be performed by a greater number or fewer number of servers. One or more servers may be operated and/or maintained by the same or different entities.

In some example embodiments, the image annotation system 100 may include one or more servers implementing an imaging system 105, a segmentation engine 120, an annotation controller 135, and one or more client devices 132. As shown in FIGS. 1A-B, the imaging system 105, the segmentation engine 120, the annotation controller 135, and the one or more client devices 132 may be communicatively coupled with one another over a network 130. The imaging system 105, the segmentation engine 120, and the annotation controller 135 may each include one or more electronic processors, electronic memories, and other appropriate electronic components for executing instructions such as program code and/or data stored on one or more computer readable mediums to implement the various applications, data, and steps described herein. For example, such instructions may be stored in one or more computer readable media such as memories or data storage devices internal and/or external to various components of the image annotation system 100, and/or accessible over the network 130. Although a single one of the imaging system 105, the segmentation engine 120, and annotation controller 135 are shown, there can be more than one of each server.

In some example embodiments, the network 130 may be implemented as a single network or a combination of multiple networks. For example, in various embodiments, network 130 may include the Internet or one or more intranets, landline networks, wireless networks, and/or other appropriate types of networks. In another example, the network 130 may comprise a wireless telecommunications network (e.g., cellular phone network) adapted to communicate with other communication networks, such as the Internet.

In some example embodiments, the imaging system 105 may be maintained by an entity that is tasked with obtaining medical images of tissue, organ, bone, etc., samples (collectively referred to herein as “samples”) of patients or subjects for the purposes of diagnosis, monitoring, treatment, research, clinical trials, and/or the like. For example, the entity can be a health care provider that seeks to obtain medical images of an organ of a patient for use in diagnosing conditions or disease the patient may have related to the organ. As another example, the entity can be an administrator of a clinical trial that is tasked with collecting medical images of a sample of a subject to monitor changes to the sample as a result of the progression/regression of a disease affecting the sample and/or effects of drugs administered to the subject to treat the disease. It is to be noted that the above examples are non-limiting and that the imaging system 105 may be maintained by other professionals that may use the imaging system 105 to obtain medical images of samples for the afore-mentioned or any other medical purposes.

In some example embodiments, the imaging system 105 may include a medical image capture (MIC) device 110 that can be used to capture images of samples of subjects for the afore-mentioned or any other medical purposes. For example, the medical image capture device 110 may be an X-ray machine with a fixed x-ray tube that is configured to capture a radiographic medical image of a sample of a patient. As another example, the medical image capture device 110 can be an X-ray machine with a motorized x-ray source that is configured to capture a computed tomography (CT) medical image of a sample of a patient, i.e., the medical image capture device 110 can be a computed tomography (CT) imaging device.

In some example embodiments, the medical image capture device 110 can be or include an optical coherence tomography (OCT) system that is configured to capture a sample of a patient such as but not limited to retina of the patient. In some instances, the optical coherence tomography (OCT) system can be a large tabletop configuration used in clinical settings, a portable or handheld dedicated system, or a “smart” optical coherence tomography (OCT) system incorporated into user personal devices such as smartphones. In some example embodiments, the medical image capture device 110 can be a magnetic resonance imaging (MRI) scanner or machine that is configured to capture magnetic resonance imaging (MRI) images of a subject or patient, or a sample thereof. In some example embodiments, the medical image capture device 110 can be an ultrasound machine that is configured to generate an ultrasound image of a sample of a patient based on sound waves reflected of the sample.

In some example embodiments, the medical image capture device 110 may include a confocal scanning laser ophthalmoscopy (cSLO) instrument that is configured to capture an image of the eye including the retina, i.e., retinal images. In some instances, the confocal scanning laser ophthalmoscopy instrument may be used for retinal imaging modalities such as but not limited to fluorescein angiography, indocyanine green (ICG) angiography, fundus autofluorescence, color fundus, and/or the like.

In some example embodiments, the imaging system 105 may include an image denoiser module 115 that is configured to recognize and remove noise from images (e.g., medical images captured by and received from the medical image capture device 110), where image noise may be understood without limitations as including distortions, stray marks, variations in image qualities such as brightness, color, etc., that are not present in or do not correctly reflect/show the samples which are captured by the images. In some instances, the image denoiser module 115 may include spatial domain methods or algorithms such as but not limited to spatial domain filtering, variational denoising methods, etc. In some instances, the image denoiser module may include transform domain methods or algorithms (e.g., using Fourier transform). In some example embodiments, the image denoiser module 115 may be or include an AI-enabled image denoiser, e.g., the image denoiser module 115 may include an AI or ML algorithm that is trained on a large training dataset of images to determine the presence of noise in an image and remove or modify the noise to improve the quality of the image. For instance, the image denoiser module 115 may include a convolutional neural network (CNN)-based denoising method or algorithm including but not limited to multi-layer perception methods, deep learning methods, etc. In some example embodiments, the image denoiser module of the image denoiser 115 used to denoise the medical images captured by the medical image capture device 110 include the enhanced visualization and layer detection algorithms discussed in Reisman et al., “Enhanced Visualization and Layer Detection via Averaging Optical Coherence Tomography Images,” Investigative Ophthalmology & Visual Science, April 2010, Vol. 51, 3859, the universal digital filtering algorithms discussed in J. Yang et al., “Universal Digital Filtering For Denoising Volumetric Retinal OCT and OCT Angiography in 3D Shearlet Domain”, Optics Letters, Vol. 45, Issue 3, p. 694-697 (2020), the deep learning-based noise reduction algorithm discussed in Z. Mao et al., “Deep Learning Based Noise Reduction Method for Automatic 3D Segmentation of the Anterior of Lamina Cribrosa in Optical Coherence Tomography Volumetric Scans,” Biomedical Optics Express, Vol. 10, Issue 11, pp. 5832-5851 (2019), and the Noise2Noise denoiser discussed in J. Lehtinen et al., “Noise2Noise: Learning Image Restoration without Clean Data,” Arxiv: 1803.04189 (2018), all of which are incorporated by reference herein in their entireties.

In some example embodiments, the segmentation engine 120 may be maintained by an entity that is tasked with labeling or annotating medical images of samples. For example, the entity can be the healthcare provider or the clinical trial administrator discussed above that maintains the imaging system 105. Although FIGS. 1A-1B show the imaging system 105 and the segmentation engine 120 as two separate components, in some example embodiments, the imaging system 105 and the segmentation engine 120 may be parts of the same system or module (e.g., and maintained by the same entity such as a health care provider or clinical trial administrator).

In some example embodiments, the segmentation engine 120 may include a machine learning model 125, which can be implemented a single neural network or a system that includes any number of or combination of neural networks. In some cases, the one or more neural networks implementing the machine learning model 125 may be convolutional neural networks (CNNs). However, it should be appreciated that the machine learning model 125 may include a variety of different types of neural networks including, for example, a Feedforward Neural Network (FNN), a Recurrent Neural Network (RNN), a Modular Neural Network (MNN), a Convolutional Neural Network (CNN), a Residual Neural Network (ResNet), an Ordinary Differential Equations Neural Networks (neural-ODE), and/or the like.

In some example embodiments, the machine learning model 125 may be implemented as one or more encoders, decoders, or autoencoders. In some cases, the one or more encoders, decoders, and/or autoencoders may be implemented via one or more neural networks. For example, in some cases, the one or more encoders, decoders, and/or autoencoders may be implemented using one or more convolutional neural networks (CNNs). Alternatively and/or additionally, the one or more encoders, decoders, and/or autoencoders may be implemented as a Y-Net (Y-shaped neural network system) or a U-Net (U-shaped neural network system).

In some example embodiments, the annotation controller 135 may be maintained by an entity that is tasked with receiving one or more medical images from the segmentation engine 120 and providing medical image reviewers 140, 145 access to the medical images for annotation. For example, as shown in FIGS. 1A-1B, the annotation controller 135 can be a remote server (e.g., cloud computing server) that the reviewers 140, 145 can log into, e.g., via their respective computing devices, such as the one or more client devices 132, to securely access the medical images so that the reviewers 140, 145 can review and/or update the annotations performed on the medical images by the other reviewers and/or the machine learning model 125. In some instances, the annotation controller 135 can be part of a combined or integrated system that includes the segmentation engine 120 and in some cases, the imaging system 105. In such cases, the annotation controller 135 may be maintained by an entity such as a healthcare provider, a clinical trial administrator, or any other entity such as a contractor tasked with facilitating the review of the annotated medical images by the reviewers 140, 145.

In some example embodiments, the annotation controller 135 may include a database 150, an interface 155, an evaluator 160, and an aggregator 165. In some instances, the annotation controller 135 may be or include a server having a computing platform, a storage system having the database 150, and the interface 155 configured to allow users of the annotation controller 135 to provide input. For example, the annotation controller 135 may include a storage system that includes the database 150 which may be configured to store the annotated medical images received from the segmentation engine 120. In some example embodiments, the storage system of the annotation controller 135 including the database 150 may be configured to comply with the security requirements of the Health Insurance Portability and Accountability Act (HIPAA) that mandate certain security procedures when handling of patient data HIPAA-compliant. For instance, the storage of the annotated medical images in the database 150 may be encrypted and anonymized, i.e., the annotated medical images may be encrypted as well as processed to remove and/or obfuscate personally identifying information (PII) of subjects to which the medical images belong.

In some example embodiments, the interface 155 may be configured to allow the reviewers 140, 145 to obtain access, via the respective client devices 132, to the medical images stored in the database 150 such that the reviewers 140, 145 may, via the interface 155 displayed at the respective client devices 132, review and/or update the labels assigned to the medical images by the other reviewers and/or the machine learning model 125. In some instances, the interface 155 at the annotation controller 135 can be a web browser, an application interface, a web-based user interface, etc., that is configured to receive input (e.g., feedback about the annotations). In some cases, the interface 155 may be configured to receive input remotely, for instance, from the reviewers 140, 145 via the interface 155 displayed at their respective client devices 132. For example, the interface 155 may be access via a communication link utilizing the network 130. In some instances, the communication link may be a virtual private network (VPN) that utilizes the network 130 and allows credentialed or authorized computing devices (e.g., the respective client devices 132 of the reviewers 140, 145) to access the interface 155. In some cases, the communication link may be HIPAA-compliant (e.g., the communication link may be end-to-end encrypted and configured to anonymize PII data transmitted therein).

In some example embodiments, the evaluator 160 may include an algorithm or method that may characterize, estimate, and/or measure the performances of reviewers 140, 145 that provide feedback (e.g., ratings) about the labels or annotations in the medical images. In some example embodiments, the reviewers 140, 145 may be tasked to access, via their respective client devices 132, the medical images stored at the database 150 in order to review and/or update the annotations assigned to the medical images by other reviewers and/or the machine learning model 125. For example, in some cases, the reviewers 140, 145 may update a first label assigned to a medical image (e.g., by another reviewer and/or the machine learning model 125) by correcting the first label and/or assigning a second label to the medical image. In some cases, in addition to updating the first label assigned to the medical image, the reviewers 140, 145 may provide, via their respective client devices 132, one or more inputs indicating whether the first label assigned to the medical image is correct, for example, in that the first label correctly identifies one or more corresponding features depicted in the medical image. As another example, the one or more inputs from the reviewers 140, 145 may include ratings indicating the level of accuracy of the first label. It is to be noted that the above examples are non-limiting and that the inputs from the reviewers 140, 145 can be in any form to convey the quality of the first label (e.g., accuracy, completeness, and/or the like).

In some example embodiments, the evaluator 160 may be configured to characterize, estimate, and/or measure the performances of the reviewers 140, 145 in providing label correction data about the labels or annotations. In some instances, the first set of reviewers 140 tasked with reviewing a medical image of a sample of a subject may be crowd-sourced individuals without expertise in the medical field related to the sample or medical issues, conditions, diseases, etc., associated with the sample. For example, if the sample is a retina or an eye tissue, the first set of reviewers 140 may be individuals with little or no expertise in ophthalmology. In some instances, there can be any number of the first set of reviewers 140, i.e., the number of the first set of reviewers 140 can be 1, 2, 3, 4, 5, etc. The second set of reviewers 145 may be subject matter experts in the medical field (e.g., ophthalmologists in the afore-mentioned example). In some instances, there can be any number of the second set of reviewers 145, i.e., the number of the second set of reviewers 145 can be 1, 2, 3, 4, 5, etc. In such embodiments, the evaluator 160 may apply an algorithm configured to measure or estimate the performance of the first set of reviewers 140 in providing feedback such as but not limited to ratings about the annotations in the medical image made by the first set of reviewers 140. The output from the evaluator 160, which may include the measure or estimation of the performance of the first set of reviewers 140, may then be used to identify which medical images annotated by the first set of reviewers 140 are escalated for review the second set of reviewers 145. For instance, in some cases, medical images annotated by reviewers whose performance fails to satisfy a certain threshold may be excluded from further review by the second set of reviewers 145 while those annotated by reviewers whose performance satisfy the threshold may be subjected to further review and verification by the second set of reviewers 145.

In some example embodiments, the evaluator 160 may also characterize, estimate, or measure the performances of the second set of reviewers 145 in the further review of the annotations. For example, the algorithm may generate the performance measures or estimates of the first set of reviewers 140 and the second set of reviewers 145 may select which of the images reviewed by the first set of reviewers 140 to further review based on the performance measures or estimates. For instance, because those first set of reviewers 140 with high performance measures or estimates may be more reliable in providing more accurate feedback on the annotations in the medical images, the second set of reviewers 145 may use their respective client devices 132b to review those annotated medical images reviewed by those first set of reviewers 140 having a performance measure or score exceeding a threshold value (e.g., top 50% of the first set of reviewers 140 as measured by the performance measures or scores).

In some example embodiments, the evaluator 160 may compute a performance measure or score of a reviewer of the first set of reviewers 140 by (i) normalizing the intersection over union (IOU) of that reviewer's label correction feedback on each feature in the corrected labeled image that the reviewer reviewed or about which the reviewer provided label correction feedback on, (ii) computing the weighted sum of all normalized IOUs of one or more features in the labeled image, where the weights correspond to the importance levels of the one or more features, and then (iii) averaging the weighted sum across multiple images that the reviewer provided label correction feedback on.

In some example embodiments, instead of or in addition to using a performance measure or score to select which annotated medical images reviewed by the first set of reviewers 140 should be reviewed by the second set of reviewers 145, the annotation controller 135 may include an aggregator 165 configured to combine the annotated medical images reviewed by the first set of reviewers 140 into one or more medical images including the feedback of some or all of the first set of reviewers 140 that may then be reviewed by the second set of reviewers 145. For example, if five reviewers of the first set of reviewers 140 reviewed an annotation in a medical image each providing his/her respective feedback, the algorithm may combine these five feedbacks into one or more feedbacks (e.g., but less than five) so that the one or more medical images generated by the annotation controller 135 to be reviewed by the second set of reviewers 145 includes the combined one or more feedbacks. To combine the annotated medical images reviewed by the first set of reviewers 140, the aggregator 165 may apply a variety of techniques including the simultaneous truth and performance level estimation (STAPLE) algorithm, discussed in S. K. Warfield et al., Simultaneous Truth and Performance Level Estimation (STAPLE): An Algorithm for the Validation of Image Segmentation, IEEE Trans Med Imaging, 23(7), pp. 903-921, July 2004, which is incorporated by reference herein in its entirety.

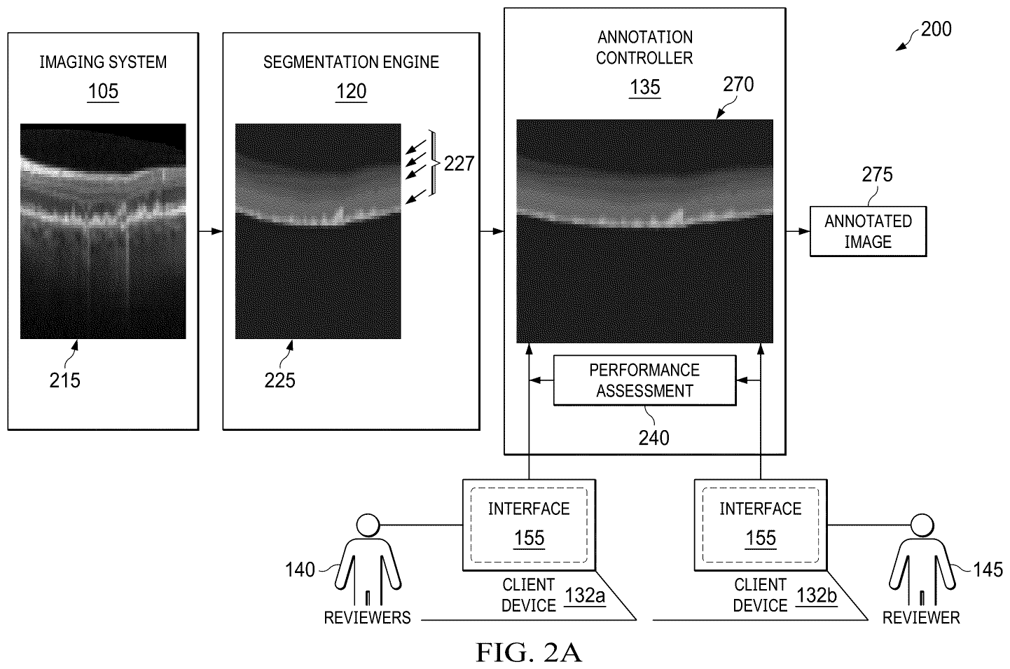

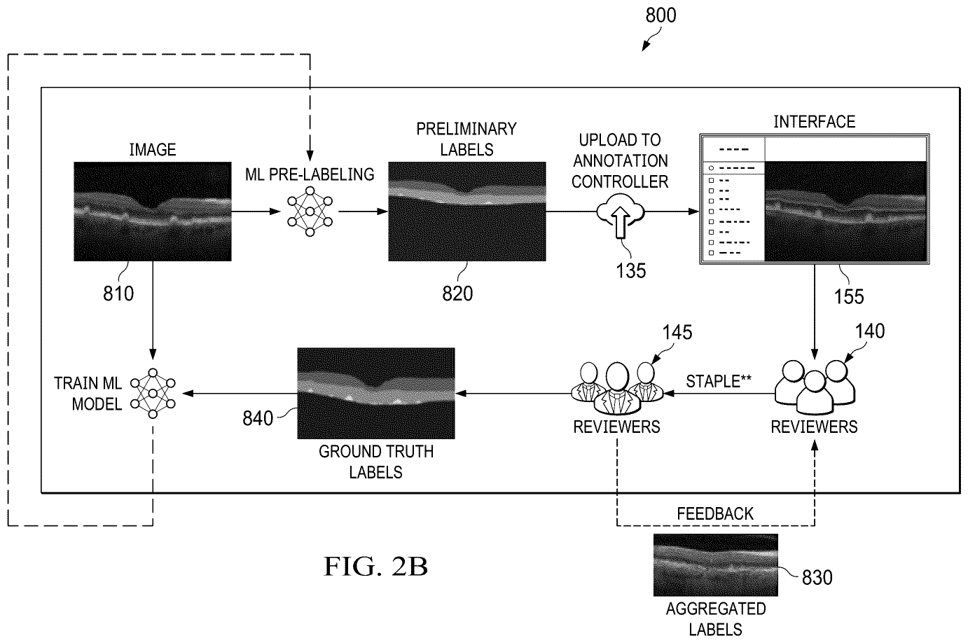

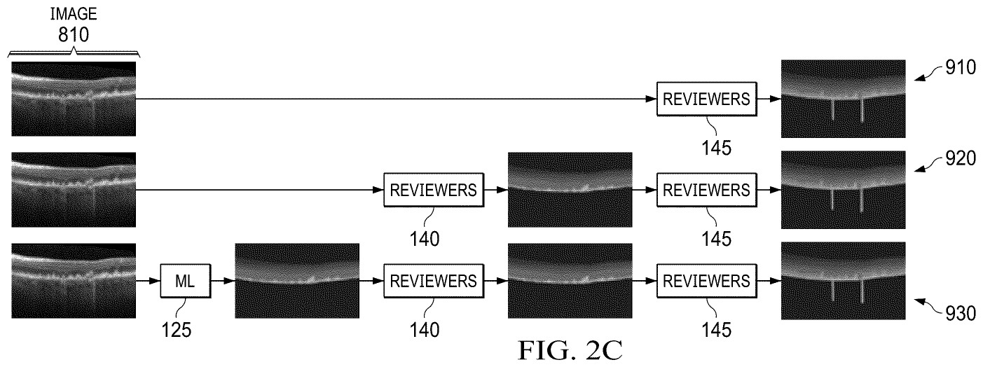

FIG. 2A depicts a flowchart illustrating an example of a process 200 for annotating medical images in accordance with various embodiments of the present disclosure. Although FIG. 2A shows example of optical coherence tomography (OCT) scans depicting the retina of an eye (e.g., retinal medical images), the workflow directed to annotating optical coherence tomography (OCT) with labels identifying various features of the retina may also be applied towards annotating other types of medical images including those of different modalities and depicting other anatomical structures (e.g., tissues, organs, bones, etc.). Accordingly, the examples of medical images described with respect to FIG. 2A and the corresponding discussion about the annotation workflow are intended as non-limiting illustrations and same or substantially similar method steps may apply for annotating other types of medical images (e.g., dental medical images, etc.).

In some example embodiments, the imaging system 105 may capture an image, such as an optical coherence tomography (OCT) scan of the retina of an eye. The imaging system 105 may process the image which may include, for example, the image denoiser 115 removing noises and other artifacts to generate the medical image 215 depicting the retina. Accordingly, in the example of the process 200 shown in FIG. 2A, the imaging system 105 can include an optical coherence tomography (OCT) imaging system configured to capture an optical coherence tomography (OCT) scan of the retina, a confocal scanning laser ophthalmoscopy (cSLO) imaging system configured to capture a fundus autofluorescence (FA:F) image of the retina, and/or the like. The medical image 215 may be an optical coherence tomography (OCT) scan and/or a fundus autofluorescence (FAF) image that depicts various regions of the retina as well as one or more boundaries therebetween. For example, the medical image 215 may show the vitreous body of the eye, the inner limiting membrane (ILM) of the retina, the external or outer plexiform layer (OPL) of the retina, the retinal pigment epithelium (RPE) of the retina, Bruch's membrane (BM) of the eye, and/or the like.

In some example embodiments, the medical image 215 may also show regions or boundaries therebetween that correspond to one or more abnormalities and/or morphological changes not present in the retina of a healthy eye. Examples of such abnormalities and/or morphological changes include deposits (e.g., drusen), leaks, and/or the like. The presence of such abnormalities and/or morphological changes in the medical image 215 may be indicative of the eye being affected by some ophthalmological disease or condition. Other examples of abnormalities and/or morphological changes indicative of disease may include distortions, attenuations, abnormalities, missing regions and boundaries, and/or the like. For example, a missing retinal pigment epithelium (RPE) in the medical image 215 may be an indication of retinal degenerative disease. One example of a retinal degenerative disease that manifests itself with morphological changes such as the appearance or disappearance of certain features in the eye tissues and particularly the retina is age-related macular degeneration (AMD) disease.

Age-related macular degeneration (AMD) is a leading cause of vision loss in patients above a certain age (e.g., 50 years or older). Initially, age-related macular degeneration (AMD) manifests as a dry type of age-related macular degeneration (AMD) before progressing to a wet type at a later stage. For the dry type, small deposits, called drusen, form beneath the basement membrane of the retinal pigment epithelium (RPE) and the inner collagenous layer of the Bruch's membrane (BM) of the retina, causing the retina to deteriorate in time. In its advanced stage, dry age-related macular degeneration (AMD) can appear as geographic atrophy (GA), which is characterized by progressive and irreversible loss of choriocapillaries, retinal pigment epithelium (RPE), and photoreceptors. Wet type age-related macular degeneration (AMD) manifests with abnormal blood vessels originating in the choroid layer of the eye growing into the retina and leaking fluid from the blood into the retina. Age-related macular degeneration (AMD), and its various manifestations, can be monitored and diagnosed using medical images of the eye, such as medical image 215, as discussed below, with the medical image 215 being one of a variety of modalities such as a fundus autofluorescence (FAF) image obtained by confocal scanning laser ophthalmoscopy (cSLO) imaging, a computed tomography (CT) scan, an optical coherence tomography (OCT) image, an X-ray image, an magnetic resonance imaging (MRI) scan, and/or the like.

In some example embodiments, the segmentation engine 120 may receive the medical image 215, which may be denoised, from the imaging system 105. The medical image 215 may be an image of a sample of a subject, the sample including a feature which can be, for example, a prognosis biomarker of a disease. For example, the medical image 215 may be an image of an eye or a retina that may include some or all of the aforementioned regions, boundaries, etc., as features (e.g., as well as the absence of one in locations where one exists in a healthy eye). Accordingly, the medical image 215 may show features such as but not limited an inner limiting membrane (ILM), an external or outer plexiform layer (OPL), a retinal pigment epithelium (RPE), a Bruch's membrane (BM), etc., morphological changes to any of the preceding eye tissues, as well as the presence of a drusen, a reticular pseudodrusen (RPD), a retinal hyperreflective foci (e.g., a lesion with equal or greater reflectivity than the retinal pigment epithelium (RPE)), a hyporeflective wedge-shaped structure (e.g., appearing within the boundaries of the outer plexiform layer (OPL)), choroidal hypertransmission defects, and/or the like. Examples of morphological changes in the noted eye tissues include shape/size distortions, defects, attenuations, abnormalities, absences, etc. in or of the tissues. For instance, the medical image may show an attenuated, abnormal or absent retinal pigment epithelium (RPE), which may be considered as a feature of the retina depicted in the medical image 215.

In some example embodiments, upon receiving the medical image 215 including one or more of the above-discussed features, the segmentation engine 120 may apply the machine learning model 125 to generate annotations or labels identifying each of the features. In some cases, the segmentation engine 120 may be tasked with identifying features in the medical image 215 that are indicative of diseases, conditions, health status, etc., and the segmentation engine 120 may generate annotations for those features that the segmentation engine 120 determines are indicative of those diseases, conditions, health status, etc. For example, if the segmentation engine 120 is tasked with identifying and annotating or labeling features on the medical image 215 that are indictors or prognosis biomarkers of age-related macular degeneration (AMD), the segmentation engine 120 may then generate annotations and labels representing those features on the medical image 215 that the segmentation engine 120 considers to be indictors or prognosis biomarkers of age-related macular degeneration (AMD). For instance, the segmentation engine 120 may generate annotations for any of the eye tissues mentioned above, as well as to regions and boundaries associated with the eye tissues. As a non-limiting illustrative example, the segmentation engine 120 may apply the machine learning model 125 (e.g., a neural network and/or the like) to generate annotations for one or more of deposits in the retina (e.g., drusen, reticular pseudodrusen (RPD), retina hyperreflective foci, and/or the like), retinal structures (e.g., the inner limiting membrane (ILM), the outer plexiform layer (OPL), the retinal pigment epithelium (RPE), the Bruch's membrane (BM)), and the boundaries between or around various retinal structures (e.g., the boundary between the vitreous body of the eye and the inner limiting membrane (ILM), the outer boundary of the outer plexiform layer (OPL), the inner boundary of the retinal pigment epithelium (RPE), the boundary between the retinal pigment epithelium (RPE) and the Bruch's membrane (BM), and/or the like).

In some example embodiments, the segmentation engine 120 may apply the machine learning model 125 to generate a labeled image 225 including the aforementioned annotations. For example, the segmentation engine 120 may superimpose the labels associated with one or more retinal structures, abnormalities, and/or morphological changes on the medical image 215 to generate the labeled image 225. In some instances, the labels may have any form on the labeled image 225 provided the annotated features can be distinguished from each other based on the corresponding labels. For instance, the annotations can be color-coded markings, texts, and/or the like. As a non-limiting illustrative example, the labeled image 225 shows various annotations 227 identifying the boundaries between various retinal structures.

It should be appreciated that although the above discussion is directed to examples where the medical image 215 depicts the retina of an eye and features being identified are biomarkers for age-related macular degeneration (AMD), the same or similar annotation workflow may apply to other types of medical images including those of different modalities and/or depicting different tissues. For example, the medical image 215 can be an ultrasound image of a liver and the feature being identified can be a tumor, the medical image 215 can be a computed tomography (CT) scan of a kidney and the feature being identified can be a kidney stone, the medical image 215 can be an X-ray image of a tooth and the feature being detected can be a root canal, and/or. That is, it is to be understood that, without limitations, the segmentation engine 120 may generate annotations representing any type of features present in the medical image 215 (e.g., such as the root canal in the X-ray image of the tooth) such that the resulting labeled image 225 include labels identifying such features.

In some example embodiments, the annotations of the features on the labeled image 225 may have associated therewith probability or confidence values indicating the level of confidence that the annotations correctly identify the features. That is, when generating the labeled image 225, the segmentation engine 120 may also generate a confidence value for each of one or more of the annotations in the labeled image 225 representing a feature that indicates the level of confidence that that annotation correctly labels the feature in the labeled image 225. In some instances, the probability or confidence values may be in any form (e.g., percentages, a value within a range, and/or the like).

In some example embodiments, the segmentation engine 120 may provide the labeled image 225 to the annotation controller 135 to prompt the annotation controller 135 to present the labeled image 225 in the interface 155 of the annotation controller 135. In some cases, the annotation controller 135 may be prompted to make the labeled image 225 accessible to the first set of reviewers 140, that may have little or no formal expertise with the sample captured by the medical images 215, 225 and may be tasked with providing label correction feedback about the annotations or labels in the labeled medical image 225, via their respective client devices 132a in communication with the annotation controller 135. For instance, the labeled image 225 may be an image of a retina annotated by the machine learning model 125 of the segmentation engine 120 and the first set of reviewers 140 may be individuals with little or no experience or expertise with age-related macular degeneration (AMD), the retina, and/or the like. In some instances, the interface 155 of the annotation controller 135 may be a web browser, an application interface, a web-based user interface, etc., and the first set of reviewers 140 may obtain access to the labeled image 225 via the interface 155 displayed at the first client devices 132a and provide the label correction feedback via the interface 155 as well.

In some example embodiments, the label correction feedback provided by the first set of reviewers 140 via the interface 155 displayed at the first client devices 132a with respect to the labeled image 225 can include affirmations, rejections, or modifications of the annotations representing the features in the labeled image 225. For example, a reviewer may indicate that an annotation is correct or not correct, and/or modify the annotation. For instance, if an annotation labels a region in the labeled image as a drusen, the label correction feedback from one or more of the first set of reviewers 140 may include an indication that the annotation is accurate, an indication that the annotation is inaccurate, and/or a modification to the annotation (e.g., changing size/shape, etc., of the marking outlining the region). In some cases, the one or more of the first set of reviewers 140 may not provide feedback (e.g., when uncertain about the annotation, or indicate the uncertainty). In some instances, there can be any number of the first set of reviewers 140, e.g., the number of reviewers in the first set of reviewers 140 can be 1, 2, 3, 4, 5, and/or the like.

In some example embodiments, the first set of reviewers 140 may provide label correction feedback on each of the annotations in the labeled image 225 to generate the corrected labeled image 270. In some instances, the first set of reviewers 140 may provide label correction feedback on a select number of annotations. For example, these select number of annotations may be those annotations associated an above-threshold confidence or probability values. Accordingly, if the segmentation engine 120 has generated a percentage value indicating the confidence level that an annotation representing a feature in the labeled image 225 is correct, then the first set of reviewers 140 may review the annotation and provide label correction feedback when the generated percentage is equal to or greater than a minimum confidence threshold.

In some example embodiments, the corrected labeled image 270 and the label correction feedback from the first set of reviewers 250 may be made accessible, for example by the annotation controller 135, to the second set of reviewers 145 that may be subject matter experts on the sample captured by the medical images 215, 225, 270 and related issues. For instance, when the labeled image 225 show a retina, the second set of reviewers 145 can be ophthalmologists or radiologists that have at least some expertise in identifying the features related to age-related macular degeneration (AlvID) in a medical image of the retina. In some example embodiments, the annotation controller 135 may also generate, for example using the evaluator 160, a reviewer performance assessment 240 of the performances of the first set of reviewers 140 in reviewing the annotations in the labeled image 225 and providing the label correction feedback.

In some example embodiments, the reviewer performance assessment 240 associated with a reviewer of the first set of reviewers 250 may include a reviewer performance score measuring or characterizing the performance of that reviewer m providing accurate label correction feedback on annotations of features in the corrected labeled image 270. For example, the label correction feedback from a reviewer may include a reviewer approving, rejecting, or modifying the feature annotations on the corrected labeled image 270. In such embodiments, the reviewer performance assessor of the annotation controller 135 may generate the reviewer performance score of that reviewer as discussed above. That is, the reviewer performance assessor may generate the reviewer performance score by (i) normalizing the intersection over union (IOU) of the reviewer's label correction feedback on each feature in the corrected labeled image 270 that the reviewer reviewed or about which the reviewer provided label correction feedback on, (ii) computing the weighted sum of all normalized intersection over union (IOU) of one or more features in the labeled image 225, where the weights correspond to the importance levels of the one or more features, and then (iii) averaging the weighted sum across multiple images that the reviewer provided label correction feedback on.

In some instances, the intersection over union (IOU) of a reviewer's label correction feedback on a given feature may be normalized by first calculating the median and range of the intersection over union (IOU) scores, corresponding to that feature, of the first set of reviewers 140, and then subtracting the median from the intersection over union (IOU) of the reviewer and dividing the subtracted intersection over union (IOU) by the range. Further, the weights may be pre-determined. For instance, a first feature (e.g., drusen) may be deemed to be more important than a second feature (e.g., attenuated retinal pigment epithelium (RPE)) in being indicative of a disease progression (e.g., age-related macular degeneration (AMD) progression), and in such cases, the weight attached to the first feature may be higher than the weight attached to the second feature. In some example embodiments, after the computation of the reviewer performance score by the evaluator 160 of the annotation controller 135, the annotation controller 135 may generate the reviewer performance assessment 240 to include the reviewer performance score, provide the second set of reviewers 145 (e.g., the subject matter experts) access to the corrected labeled image 270, the label correction feedback, and the reviewer performance assessment 240. In some instances, there can be any number of reviewers the second set of reviewers 145, i.e., the number of reviewers in the second set of reviewers 145 can be 1, 2, 3, 4, 5, etc.

In some example embodiments, the second set of reviewers 145 may then obtain access to the corrected labeled image 270, the label correction feedback, and the reviewer performance assessment 240 via their respective client devices 132b and evaluate the corrected labeled image 270 (e.g., and the label correction feedback of the first set of reviewers 140). For example, the evaluation may include indications whether the label correction feedback provided by the first set of reviewers 140 with respect to the annotations on the labeled image 225 are correct or not (e.g., the indications can be scores where low/high scores indicate the label correction feedback is less/more accurate). In some instances, the evaluations by the second set of reviewers 145 may be based on the label correction feedback of all the first set of reviewers 140. In some instances, however, the evaluations may be based on reviewer performance scores, i.e., whether a label correction feedback of a reviewer of the first set of reviewers 140 may depend on whether a reviewer performance score of that reviewer is less than a threshold performance score. For example, if the reviewer performance score of a reviewer of the first set of reviewers 250 is equal to or higher than the threshold performance score, the label correction feedback of that reviewer may not be evaluated by the second set of reviewers 145 (e.g., because it may be deemed to be accurate enough). In some instances, the corrected labeled image 270 (e.g., and the label correction feedback) of the first set of reviewers 140 may be combined (e.g., by applying a simultaneous truth and performance level estimation STAPLE algorithm) into one or more images to be evaluated by the second set of reviewers 145. In some instances, the label correction feedback of the first set of reviewers 140 and the evaluation of that label correction feedback by the second set of reviewers 145 may be combined into label correction data that include information about corrections performed by the reviewers 140, 145 to the annotations by the labels assigned to the labeled image 225 by the machine learning model 125 of the segmentation engine 120.

In some example embodiments, the second set of reviewers 145 can be or include an automated software. For instance, the automated software may be programmed to review or evaluate the feedbacks from the first set of reviewers 145. Alternatively and/or additionally, the automated software may be programmed to approve an annotation of a feature if the feedbacks from a majority of the first set of reviewers 145 agree on the annotation (e.g., which can be weighted based a reviewer's performance score or reputation in annotating medical images). As another example, the automated software may indicate as accurate first reviewer feedbacks that have associated intersection over union (IOU) values satisfying a threshold (e.g., exceeding a minimum intersection over union (IOU) threshold and/or the like). It should be appreciated that the above are non-limiting examples and that the software can be programmed with any mechanism or method that evaluates or scores the feedbacks from the first set of reviewers 140 for accuracy, completeness, and/or the like.

In some example embodiments, the annotation controller 135 may update the corrected labeled image 270 with an update related to the label correction data to generate the annotated image 275. In some instances, the update may include corrections to the feature annotations in the corrected labeled image 270, where the corrections are based on the evaluations of the second set of reviewers 145. For example, the machine learning model 125 of the segmentation engine 120 may have annotated a region of the medical image 215 (e.g., one or more pixels forming a region of the medical image 215) with a label indicating that the region corresponds to a particular feature of the retina (e.g., drusen). In such a case, the first set of reviewers 140 may have provided via the respective first client devices 132a label correction feedback indicating that the annotations performed by the machine learning model 125 is not correct (e.g., by modifying the label to identify the region as a reticular pseudodrusen (RPD) instead), and the second set of reviewers 145 may have evaluated the accuracy of the label correction feedback (e.g., indicate that the label correction feedback is accurate, for instance, by scoring the accuracy of the feedback). In such cases, the annotation controller 135 may update the labeled image 270 based on the label correction feedback and the evaluation of the second set of reviewers 145 to generate the annotated image 275. For instance, the annotation of the region may be updated in the annotated image 275 to indicate that the region is in fact a reticular pseudodrusen (RPD) and not a drusen as indicated by the annotation performed by the machine learning model 125. In some instances, the annotation controller 135 may compute a confidence value related to the annotation of the feature (e.g., a confidence value on whether the region is in fact a reticular pseudodrusen (RPD)).

In some example embodiments, the confidence value for an annotation of a feature in the annotated image 275 may be calculated based at least in part on the label correction feedback and/or the indications the second set of reviewers 145 assign to that label correction feedback. For example, the confidence value of a feature in the annotated image 275 may be high if the label correction feedback of the first set of reviewers 140 indicates agreement on an annotation of the feature by at least a threshold number of the first set of reviewers 140 and that at least a threshold number of the second set of reviewers 260 has approved the label correction feedback. It is to be noted that the above is a non-limiting example and the confidence value for an annotation of a feature may be computed based on any other method of generating a confidence parameter that measures the accuracy of the annotation of feature (e.g., the evaluation by the second set of reviewers 145 that are subject matter experts may be given higher weight compared to the label correction feedback by the non-experts included in the first set of reviewers 140).

In some example embodiments, the annotated image 275 may be provided to the segmentation engine 120 such that the annotated image 275 may be a part of an annotated training dataset used for training and/or updating the machine learning model 125. In some instances, as the machine learning model 125 is subjected to successive training iterations and exposed to more annotated training samples, the segmentation labels assigned by the machine learning model 125 may become more accurate, which may be reflected in more of the labels being approved by the first set of reviewers 140 in their label correction feedback and/or the evaluations of the label correction feedback by the second set of reviewers 145. In such cases, the number of reviewers 140, 145 engaged in the hierarchical annotation workflow may be reduced over time, which improves the efficiency of training the machine learning model 125 while maintaining the accuracy of its output.

FIG. 2B depicts a flowchart illustrating an example of a hierarchical workflow 800 for generating annotated training data for machine learning enabled segmentations of medical images in accordance with various embodiments of the present disclosure. In some example embodiment, the annotation controller 135 may receive, for example, from the imaging system 105, an image 810 in its raw form or, in the example of the hierarchical workflow 800 shown in FIG. 2B, an annotated version of the image 810 having the preliminary labels 820 determined by a machine learning model (e.g., the machine learning model 125 or a different model). That is, in some cases, the raw version of the image 810 from the imaging system 105 may undergo machine learning enabled pre-labeling before being uploaded to the annotation controller 135 for further annotation by the first group of reviewers 140 and/or the second group of reviewers 145.

Referring again to FIG. 2B, the annotation controller 135 may receive, via the interface 155 displayed at the first client devices 132a associated with the first group of reviewers 140, a set of labels for the image 810. In some cases, that set of labels may be generated by updating, based on inputs from the first group of reviewers 140, the preliminary labels 820 determined by a machine learning model, such as the machine learning model 125 of the segmentation engine 120 or a different machine learning model. The annotation controller 135 may update, based on inputs received via the interface 155 displayed at the second client devices 132b associated with the second group of reviewers 145, the set of labels to generate the ground truth labels 840 for the image 810. In some cases, the annotation controller 135 may generate the aggregate labels 830 by at least combining the labels generated based on inputs from the first group of reviewers 140. For instance, in the example shown in FIG. 2B, the aggregate labels 830 may be generated by applying a simultaneous truth and performance level estimation (STAPLE) algorithm to determine a probabilistic estimate of the true segmentation of the image 810 by estimating an optimal combination of the individual segmentations provided by the first group of reviewers 140 and weighing each segmentation based on the performance of the corresponding reviewer.

In some example embodiments, the annotation controller 135 may generate the ground truth labels 840 by at least correcting the aggregated labels 830 based on the inputs received from the second client devices 132b of the second group of reviewers 145. Moreover, the image 810 along with the ground truth labels 830 may be provided as an annotated training sample for training the machine learning model 125. As shown in FIG. 2B, upon training, the machine learning model 125 may be deployed to pre-label the images used for subsequent training of the machine learning model 125. For example, in some cases, the segmentation performance of the machine learning model 125 may improve upon each successive training iteration during which the machine learning model 125 is trained using at least some training samples that have been pre-labeled by the machine learning model 125.

As the performance of the machine learning model 125 improves, the consensus between the labels determined by the machine learning model 125 and the labels determined based on inputs from the first group of reviewers 140 and/or the second group of reviewers 145 may increase, eventually eliminating the need for the labels determined by the machine learning model 125 to undergo further review. To further illustrate, FIG. 2C depicts various examples of workflows for generating annotated training data for machine learning enabled segmentation of medical images in accordance with various embodiments of the present disclosure. As shown in FIG. 2C, the annotation controller 135 may implement a hierarchical annotation workflow that includes any combination of machine learning based pre-labeling (e.g., by the machine learning model 125 or a different model), annotation by a first group of non-expert reviewers (e.g., the first group of reviewers 140), and annotation by a second group of expert reviewers (e.g., the second group of reviewers 145).

Referring to FIG. 2C, in the first example workflow 910, the ground truth labels 840 for the image 810 may be determined based on inputs received from the second client devices 132b of the second group of reviewers 145 (e.g., expert reviewers). In the second example workflow 920, the ground truth labels 840 of the image 810 may be determined based on a first set of labels received from the first client devices 132a of the first group of reviewers 140 (e.g., non-expert reviewers) and/or a second set of labels updating the first set of labels received from the second client devices 132b of the second group of reviewers 145 (e.g., expert reviewers). In the third example workflow 930, the ground truth labels 840 of the image 810 may be determined based on a set of preliminary labels determined by a machine learning model (e.g., the machine learning model 125 or a different model), a first set of labels updating the set of preliminary labels received from the first client devices 132a of the first group of reviewers 140 (e.g., non-expert reviewers), and/or a second set of labels updating the first set of labels received from the second client devices 132b of the second group of reviewers 145 (e.g., expert reviewers).

In some example embodiments, the machine learning model 125 trained as above may be used for the diagnosis, progression monitoring, and/or treatment of patients. For example, when diagnosing or treating a patient having a medical problem with a tissue, the machine learning model 125 trained as described above may be provided with a raw and/or a denoised image of the tissue as an input. The machine learning model 125 may identify features that are prognostic biomarkers of a disease on the image and annotate the image with labels. As a non-limiting example, the machine learning model 125 may be trained as discussed above to segment medical images depicting a retina and identify one or more features that may be prognostic biomarkers of age-related macular degeneration (AMD). Accordingly, upon being provided an image of an eye or a retina as input, the machine learning model 125 may annotate, within the image, one or more features that may be prognostic biomarkers of age-related macular degeneration (AMD) (e.g., drusen and/or the like. Applying the trained machine learning model 125 in this manner may improve the accuracy and efficiency of diagnosing and treating patients for age-related macular degeneration (AMD). The machine learning model 125 may also be used to discover biomarkers.

In some example embodiments, instead of or in addition to diagnosing and treating patients, the machine learning model 125 trained as above may be used to identify patients as candidates for clinical trials and/or separate patients into different cohorts. For instance, an administrator of a clinical trial may wish to enroll multiple subjects to study the progression of age-related macular degeneration (AMD). As such, the administrator may wish to identify subjects with the dry type of age-related macular degeneration (AMD) and the wet type of age-related macular degeneration (AMD). In such cases, the administrator may utilize the machine learning model 125 to identify, on based on medical images of various patients, one or more features that are indicative of the dry type of age-related macular degeneration (AMD) (e.g., drusen) and those that are indicative of the wet type of age-related macular degeneration (AMD) (e.g., geographic atrophy (GA)). Patients with dry type of age-related macular degeneration (AMD) may thus be distinguished from patients with wet type age-related macular degeneration (AMD). As such, the use of the trained machine learning model 125 may allow or at least facilitate the efficient and accurate administration of clinical trials. In addition, the machine learning model 125 trained as described above may further discover (new) biomarkers (e.g., in addition to known prognostic biomarkers). Such biomarkers (and/or the described neural networks) may assist in patient selection or in real-time diagnosis. In one embodiment, the machine learning model 125 may be deployed in a user device or mobile device, to further facilitate clinical trials or provide treatment recommendations.

Referring again to FIGS. 1A-1B, the annotation controller 135 may implement a hierarchical workflow for generating annotated training data in which the ground truth labels assigned to a training sample are determined based on inputs from multiple groups of reviewers such as the first group of reviewers 140 and the second group of reviewers 145. For example, to generate an annotated training sample, the annotation controller 135 may determine, based on inputs received the first client devices 132a associated with the first group of reviewers 145, a first set of labels for a medical image. The first set of labels may include one or more pixel-wise segmentation labels that assigns, to one or more pixels within the medical image, a label corresponding to an anatomical feature depicted by each pixel. In some cases, the first set of labels may be generated by updating, based on inputs from the first group of reviewers 140, a set of preliminary labels determined by a machine learning model, such as the machine learning model 125 of the segmentation engine 120 or a different machine learning model.

In some cases, the annotation controller 135 may determine that a certain level of discrepancy is present within the first set of labels determined based on inputs received from the first group of reviewers 140. For example, the annotation controller 135 may compute a consensus metric, such as an intersection over union (IOU) and/or the like, for the first set of labels. The consensus metric may be indicative of the accuracy of the first set of labels by at least indicate a level of agreement or discrepancy between the labels assigned to each pixel of the medical image by different reviewers within the first group of reviewers 140, with the first set of labels being considered more accurate when there is less discrepancy between the labels assigned by different reviewers. In the event the consensus metric for the first set of labels fails to satisfy a threshold (e.g., the consensus metric of the first set of labels is below a threshold value), the medical image may be escalated for in-depth review by the second group of reviewers 145. That is, in some cases, the first set of labels may be subjected to review by the second group of reviewers 145 if the consensus metric associated with the first set of labels fails to satisfy a threshold such as by being below a threshold value in some scenarios, above a threshold in another scenario, within a given range, or outside of a given range. In some cases, the threshold values and ranges may change through adaptive learning of the system 100. Alternatively, the first set of labels may be reviewed by the second group of reviewers 145 even if the consensus metric for the first set of labels does satisfy the threshold (e.g., when the consensus metric of the first set of labels is above the threshold value). However, in those cases, the first set of labels may be flagged for more in-depth review if the consensus metric of the first set of labels fails to satisfy the threshold.

In some example embodiments, the annotation controller 135 may determine a second set of labels for the medical image by at least updating the first set of labels based on inputs received the second client devices 132b associated with the second group of reviewers 145. In some example embodiments, the annotation controller 135 may generate the interface 155 (e.g., a graphic user interface (GUI)) to display an aggregate of the first set of labels associated with the medical image such that the inputs received from the second group of reviewers 145 include corrections of the aggregate of the first set of labels. It should be appreciated that the annotation controller 135 may determine the aggregate of the first set of labels in a variety of ways.

In one example, the annotation controller 135 may aggregate the first set of labels by applying a simultaneous truth and performance level estimation (STAPLE) algorithm to determine a probabilistic estimate of the true segmentation of the medical image by estimating an optimal combination of the individual segmentations provided by the first group of reviewers 140 and weighing each segmentation based on the performance of the corresponding reviewer. For example, the first set of labels may include, for a pixel within the medical image, at least a first label assigned to the pixel by a first reviewer from the first group or reviewers 140, a second label assigned to the pixel by a second reviewer from the first group of reviewers 140, and a third label assigned to the pixel by a third reviewer from the third group of reviewers 140. Each of the first label, the second label, and the third label may identify the pixel as belonging to a feature present in the medical image such as a retinal structure, abnormality, morphological change, and/or the like. To combine the first label, the second label, and the third label into a single aggregated label for the pixel, the annotation controller 135 may weight each of the first label, the second label, and the third label based on the accuracy of the corresponding first reviewer, second reviewer, and third reviewer. Accordingly, the first label may be weighted the higher than the third label but lower than the second label if the first reviewer is associated with a higher accuracy than the third reviewer but a lower accuracy than the second reviewer.

In some example embodiments, the annotation controller 135 may determine, based at least on the second set of labels, one or more ground truth labels for the medical image. For example, in some cases, the ground truth labels for the medical image may correspond to the second set of labels, which are generated by the annotation controller 135 updating the first set of labels based on inputs received from the second set of reviewers 145. Alternatively, the annotation controller 135 may generate the ground truth labels for the medical image by combining the first set of labels with the second set of labels. For instance, the annotation controller 135 may combine the first set of labels with the second set of labels by at applying a simultaneous truth and performance level estimation (STAPLE) algorithm. As noted, the simultaneous truth and performance level estimation (STAPLE) algorithm may determine a probabilistic estimate of the true segmentation of the medical image by estimating an optimal combination of the individual segmentations provided by each reviewer. Accordingly, in this case, the ground truth label for a pixel within the medical image may correspond to a weighted combination of at least a first label assigned to the pixel by a first reviewer from the first group of reviewers 140 and a second label assigned to the pixel by a second reviewer from the second group of reviewers 145. The second set of labels may be weighted higher than the first set of labels at least because the second set of reviewers 145 are experts associated with a higher accuracy than the non-experts forming the first set of reviewers 140.

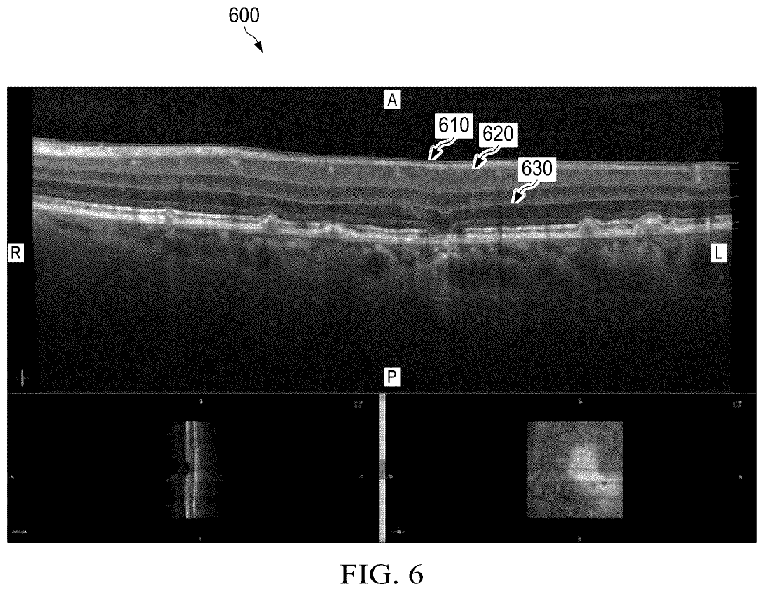

The medical image and the one or more ground truth labels associated with the medical image may form an annotated training sample for training the machine learning model 125 to perform segmentation of medical images. For example, a training dataset including the annotated training sample may be used to train the machine learning model 125 to assign, to each pixel within a medical image, a label indicating whether the pixel forms a portion of an anatomical feature depicted in the medical image. Training the machine learning model 125 to perform image segmentation may include adjusting the machine learning model 125 to minimize the errors present in the output of the machine learning model 125. For instance, the machine learning model 125 may be trained by at least adjusting the weights applied by the machine learning model 125 in order to minimize a quantity of incorrectly labeled pixels in the output of the machine learning model 125. Further illustration is included at FIG. 6, which depicts an annotated image, in accordance with various embodiments of the present disclosure.

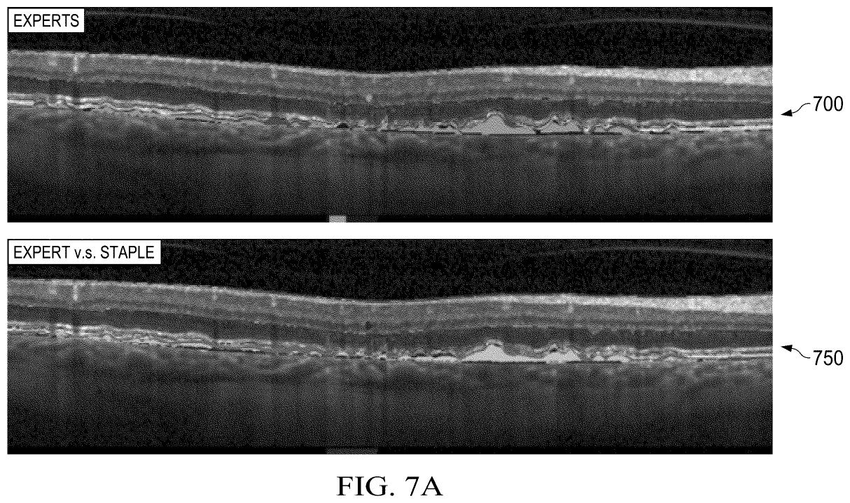

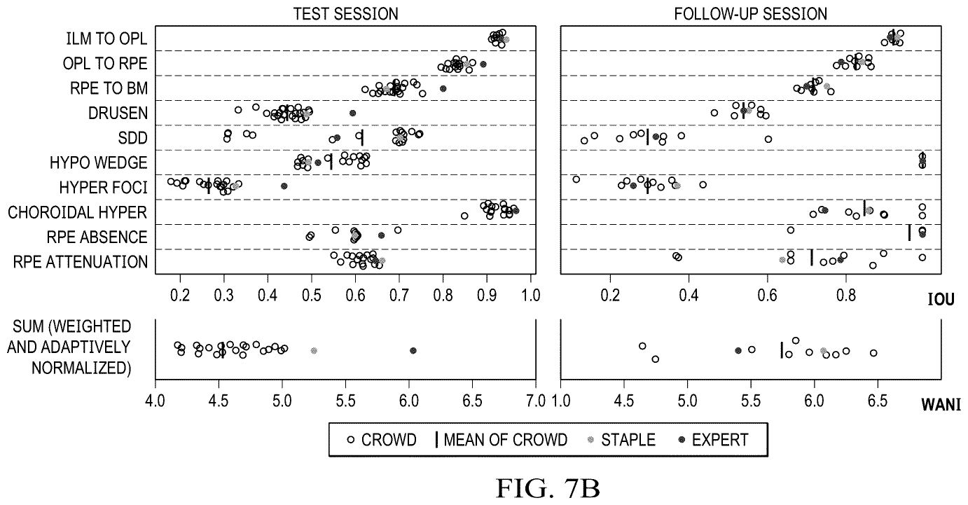

As noted, in some example embodiments, the annotation controller 135 may determine the ground truth labels associated with a training sample based on inputs from multiple groups of reviewers such as the first group of reviewers 140 and the second group of reviewers 145. For example, in some cases, the first group of reviewers 140 may be non-experts whereas the second group of reviewers 145 may be experts. The annotation engine 135 may implement the aforementioned hierarchical workflow, which includes successive updates to the preliminary labels generated by a machine learning model (e.g., the machine learning model 125 or a different model), the first set of labels determined based on inputs from the first group of reviewers 140, and/or the second set of labels determined based on inputs from the second group of reviewers 145, to reconcile discrepancies amongst the labels and, in doing so, minimize the errors that may be present therein. Examples of qualitative evaluations are provided at FIGS. 7A and 7B.

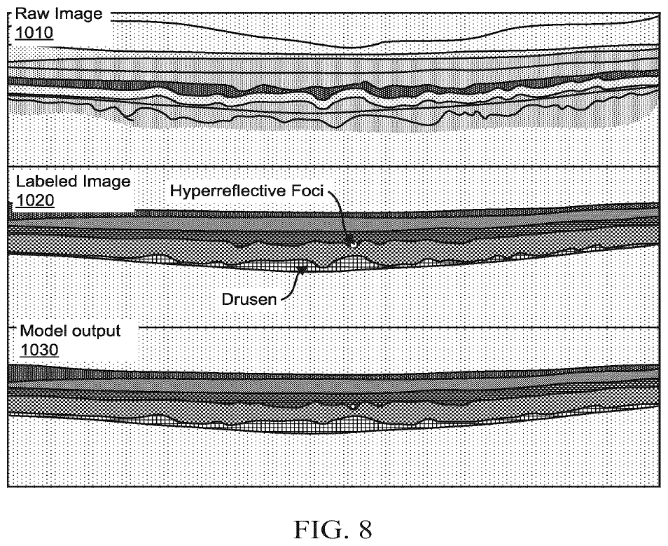

In some example embodiments, upon training the machine learning model 125 to perform image segmentation, the trained machine learning model 125 may be deployed to segment medical images, which includes assigning one or more labels to identify one or more features present within the medical images. For example, where the medical image is an optical coherence tomography (OCT) scan, one or more pixels of the medical image may be assigned a label corresponding to retinal structures such as an inner limiting membrane (ILM), an external or outer plexiform layer (OPL), a retinal pigment epithelium (RPE), a Bruch's membrane (BM), and/or the like. In some cases, one or more pixels of the medical image may also be assigned a label corresponding to abnormalities and/or morphological changes such as the presence of a drusen, a reticular pseudodrusen (RPD), a retinal hyperreflective foci (e.g., a lesion with equal or greater reflectivity than the retinal pigment epithelium), a hyporeflective wedge-shaped structure (e.g., appearing within the boundaries of the outer plexiform layer), choroidal hypertransmission defects, and/or the like. An illustration of a raw image, a labeled image with annotations, and a machine learning model 125 output is provided at FIG. 8.

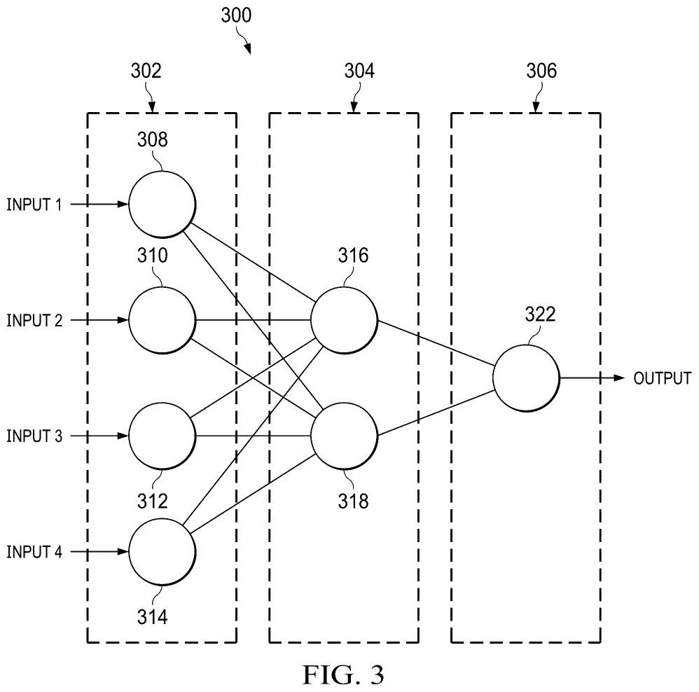

FIG. 3 depicts a schematic diagram illustrating an example a neural network 300 that can be used to implement the machine learning model 125 in accordance with various embodiments of the present disclosure. As shown, the artificial neural network 300 may include an input layer 302, a hidden layer 304, and an output layer 306. Each of the layers 302, 304, and 306 may include one or more nodes. For example, the input layer 302 includes nodes 308-314, the hidden layer 304 includes nodes 316-318, and the output layer 306 includes a node 322. In this example, each node in a layer is connected to every node in an adjacent layer. For example, the node 308 in the input layer 302 is connected to both of the nodes 316, 318 in the hidden layer 304. Similarly, the node 316 in the hidden layer is connected to all of the nodes 308-314 in the input layer 302 and the node 322 in the output layer 306. Although only one hidden layer is shown for the artificial neural network 300, it has been contemplated that the artificial neural network 300 used to implement the machine learning algorithms of the machine learning model 125 may include as many hidden layers as necessary or desired.

In this example, the artificial neural network 300 receives a set of input values and produces an output value. Each node in the input layer 302 may correspond to a distinct input value. For example, when the artificial neural network 300 is used to implement the machine learning model 125, each node in the input layer 302 may correspond to a distinct attribute of a medical image.

In some example embodiments, each of the nodes 316-318 in the hidden layer 304 generates a representation, which may include a mathematical computation (or algorithm) that produces a value based on the input values received from the nodes 308-314. The mathematical computation may include assigning different weights to each of the data values received from the nodes 308-314. The nodes 316 and 318 may include different algorithms and/or different weights assigned to the data variables from the nodes 308-314 such that each of the nodes 316-318 may produce a different value based on the same input values received from the nodes 308-314. In some example embodiments, the weights that are initially assigned to the features (or input values) for each of the nodes 316-318 may be randomly generated (e.g., using a computer randomizer). The values generated by the nodes 316 and 318 may be used by the node 322 in the output layer 306 to produce an output value for the artificial neural network 300. When the artificial neural network 300 is used to implement the machine learning model 125, the output value produced by the artificial neural network 300 may include an annotated image including labels identifying the features present in the image.

The artificial neural network 300 may be trained by using training data. For example, the training data herein may be raw images of samples (e.g., tissue samples such as retina) and/or annotated images with annotations or labels corrected by reviewers. By providing training data to the artificial neural network 300, the nodes 316-318 in the hidden layer 304 may be trained (adjusted) such that an optimal output is produced in the output layer 306 based on the training data. By continuously providing different sets of training data, and penalizing the artificial neural network 300 when the output of the artificial neural network 300 is incorrect (e.g., when a label assigned to the a training sample incorrectly identifies a feature), the artificial neural network 300 may be adjusted to improve its performance in data classification. Adjusting the artificial neural network 300 may include adjusting the weights associated with each node in the hidden layer 304.

Although the above discussions pertain to an artificial neural network as an example of machine learning, it is understood that other types of machine learning methods may also be suitable to implement the various aspects of the present disclosure. For example, support vector machines (SVMs) may be used to implement machine learning. Support vector machines are a set of related supervised learning methods used for classification and regression. A support vector machine training algorithm which may be a non-probabilistic binary linear classifier may build a model that predicts whether a new example falls into one category or another. As another example, Bayesian networks may be used to implement machine learning. A Bayesian network is an acyclic probabilistic graphical model that represents a set of random variables and their conditional independence with a directed acyclic graph (DAG). The Bayesian network could present the probabilistic relationship between one variable and another variable. Another example is a machine learning engine that employs a decision tree learning model to conduct the machine learning process. In some instances, decision tree learning models may include classification tree models, as well as regression tree models. In some example embodiments, the machine learning engine employs a Gradient Boosting Machine (GBM) model (e.g., XGBoost) as a regression tree model. Other machine learning techniques may be used to implement the machine learning engine, for example via Random Forest or Deep Neural Networks. Other types of machine learning algorithms are not discussed in detail herein for reasons of simplicity and it is understood that the present disclosure is not limited to a particular type of machine learning.

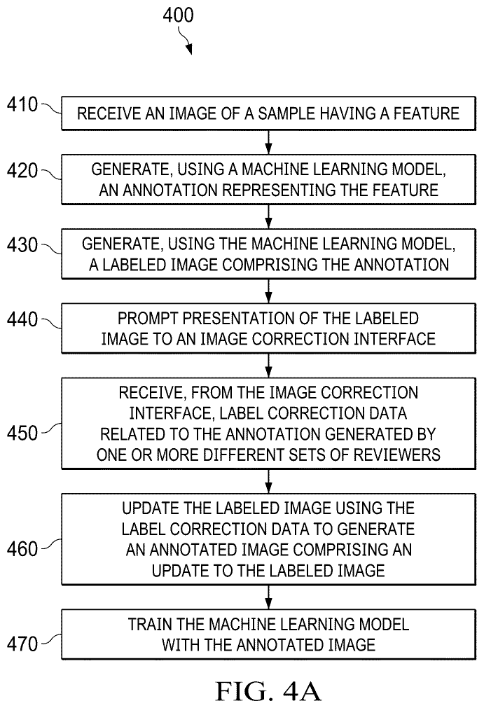

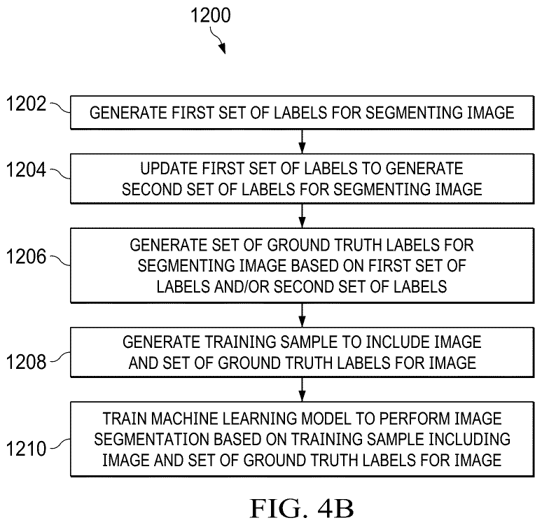

FIG. 4A depicts a flowchart illustrating an example of a process 400 of annotating medical images, according to various embodiments of the present disclosure. The various operations of the process 400, which are described in greater detail above, may be performed by one or more electronic processors. For example, at least some of the operations of the process 400 may be performed by the processors of a computer or a server implementing the machine learning model 125. Further, it is understood that additional method steps may be performed before, during, or after the operations 410-460 discussed below. In addition, in some example embodiments, one or more of the operations 410-460 may also be omitted or performed in different orders.

In some example embodiments, the process 400 includes the operation 410 of receiving an image of a sample having a feature. In some example embodiments, the feature includes a biomarker that is indicative of age-related macular degeneration (AMD).

In some example embodiments, the process 400 includes the operation 420 of generating, using a machine learning model (e.g., a neural network), an annotation representing the feature. In some example embodiments, the sample is a tissue sample or a blood sample. For instance, the sample can be a retina.

In some example embodiments, the process 400 includes the operation 430 of generating, using the machine learning model, a labeled image comprising the annotation.

In some example embodiments, the process 400 includes the operation 440 of prompting presentation of the labeled image to an image correction interface.

In some example embodiments, the process 400 includes the operation 450 of receiving, from the image correction interface, label correction data related to the annotation generated by one or more different sets of reviewers. In some example embodiments, the label correction data includes indications of affirmation, rejection, or modification of the label received at the image correction interface. In some example embodiments, the indications are input into the image correction interface by one or more trained users.

In some example embodiments, the process 400 includes the operation 460 of updating the labeled image using the label correction data to generate an annotated image comprising an update to the labeled image. In some example embodiments, the update includes a confidence value for the annotation representing the feature. In some example embodiments, the process 400 further comprises validating the annotation in the annotated image based on a comparison of the confidence value to a pre-set confidence threshold.

In some example embodiments, the process 400 includes the operation 470 of training the machine learning model with the annotated image.

FIG. 4B depicts a flowchart illustrating another example of a process 1200 for generating annotated training data for machine learning enabled segmentation of medical images in accordance with various embodiments of the present disclosure. In some example embodiments, the process 1200 may be performed, for example, by the annotation controller 135 to generate annotated training data for training the machine learning model 125 of the segmentation engine 120 to perform segmentation of various types of medical images captured at the imaging system 105. As noted, the machine learning model 125 may be trained to segment medical images of any modality including, for example, computed tomography (CT) imaging, optical coherence tomography (OCT) imaging, X-ray imaging, magnetic resonance imaging (MRI) imaging, ultrasound imaging, and/or the like.

At 1202, a first set of labels may be generated for segmenting an image. For instance, in some example embodiments, the annotation controller 135 may generate, based on inputs received from the first client devices 132a of the first set of reviewers 140, a first set of labels for segmenting an image generated by the imaging system 105. In some cases, the image may be a medical image depicting a tissue such as an optical coherence tomography (OCT) scan depicting a cross section of the retina of an eye. Accordingly, the first set of labels may include, for each pixel within the image, a label identifying the pixel as belonging to a particular feature such as, for example, one or more retinal structures, abnormalities, morphological changes, and/or the like. In some cases, such as in the example of the workflow 800 shown in FIG. 2B, the image may have undergone machine learning based pre-labeling prior to being uploaded to the annotation controller 135. That is, instead of a raw version of the image, the annotation controller 135 may receive an annotated version of the image having a set of preliminary labels generated by a machine learning model such as the machine learning model 125 of the segmentation engine 120 or a different machine learning model. In those cases, the first set of labels may include updates to the set of preliminary labels assigned to the image.

At 1204, the first set of labels may be updated to generate a second set of labels for segmenting the image. In some example embodiments, the annotation controller 135 may aggregate the first set of labels, for example, by applying the simultaneous truth and performance level estimation (STAPLE) algorithm to determine a probabilistic estimate of the true segmentation of the image by estimating an optimal combination of the individual segmentations provided by the first group of reviewers 140 and weighing each segmentation based on the performance of the corresponding reviewer. The annotation controller 135 may present, for example, via the interface 155 displayed at the second client devices 132b associated with the second set of reviewers 145, the resulting aggregated label set. For example, the interface 155 may be generated to display the image with the aggregated label set superimposed on top. Accordingly, the annotation controller 135 may receive, via the interface 155, one or more inputs from the second set of reviewers 145 with respect to the first set of labels. The inputs from the second set of reviewers 145 may confirm, refute, and/or modify the annotations associated with the first set of labels. For instance, while a pixel within the image may be assigned a first label in accordance with the first set of labels, one or more reviewers from the second set of reviewers 145 may, based on the aggregate of the first set of labels displayed in the interface 155, confirm, refute, and/or change the first label (e.g., to a second label).

In some cases, the first set of labels may be escalated for review by the second set of reviewers 145 if the consensus metric of the first set of labels fails to satisfy a threshold. For example, the first set of labels may be escalated for review by the second set of reviewers when the intersection over union (IOU) for the first set of labels does not exceed a threshold value. In some cases, the first set of labels may be escalated for review by the second set of reviewers 145 regardless of whether the consensus metric of the first set of labels satisfy the threshold. However, in those cases, the first set of labels may be flagged for more in-depth review if the consensus metric of the first set of labels fails to satisfy the threshold.

At 1206, a set of ground truth labels for segmenting the image may be generated based at least on the first set of labels and/or the second set of labels. In some example embodiments, the ground truth labels determined for the image may correspond to the second set of labels, which are generated by updating the first set of labels based on inputs received from the second set of reviewers 145. Alternatively, in some instances, the annotation controller 135 may generate the ground truth labels for the image by combining the first set of labels with the second set of labels. For example, the annotation controller 135 may combine the first set of labels with the second set of labels by at applying a simultaneous truth and performance level estimation (STAPLE) algorithm. In those cases, the ground truth label for a pixel within the image may correspond to a weighted combination of at least a first label assigned to the pixel by a first reviewer from the first group of reviewers 140 and a second label assigned to the pixel by a second reviewer from the second group of reviewers 145 with the second label being weighted higher than the first label to reflect the second set of reviewers 145 being experts associated with a higher accuracy than the non-experts forming the first set of reviewers 140.

At 1208, a training sample may be generated to include the image and the set of ground truth labels for the image. In some example embodiments, the annotation controller 135 may generate a training sample that includes the image and the ground truth labels associated with the image.

At 1210, a machine learning model may be trained to perform image segmentation based on the training sample including the image and the set of ground truth labels for the image. In some example embodiments, the annotation controller 135 may provide, to the segmentation engine 120, the training sample as a part of an annotated training dataset for training the machine learning model 125 to perform image segmentation. The training of the machine learning model 125 may include adjusting the machine learning model 125, such as the weights applied by the machine learning model 125, to minimize the errors present in the output of the machine learning model 125. The errors present in the output of the machine learning model 125 may include, for example, the quantity of incorrectly labeled pixels. An incorrectly labeled pixel may be a pixel that is assigned a label by the machine learning model 125 that does not match the ground truth label for the pixel.

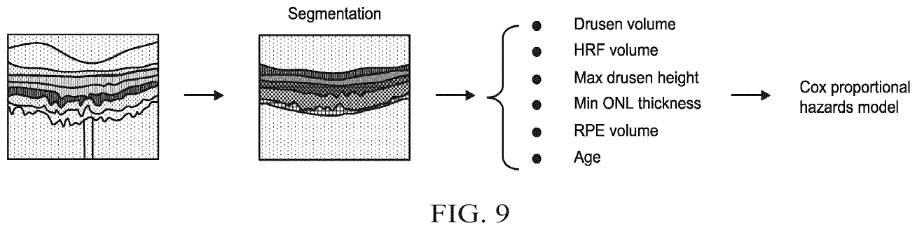

In some example embodiments, the machine learning model 125 may be trained to segment an image in order to identify, within the image, one or more features that can serve as biomarkers for the diagnosis, progression monitoring, and/or treatment of a disease. For example, the machine learning model 125 may be trained to segment an optical coherence tomography (OCT) scan to identify one or more retinal structures, abnormalities, and/or morphological changes present within the optical coherence tomography (OCT) scan. As shown in FIG. 9, at least some of those features may serve as biomarkers for predicting the progression of an eye disease, such as age-related macular degeneration (AMD) and nascent geographic atrophy (nGA).

In some example embodiments, the machine learning model 125 may be subjected to multiple iterations of training, with the performance of the machine learning model 125 improving with each successive training iteration. For example, as the machine learning model 125 undergo additional training iterations and is exposed to more training samples, the consensus between the labels determined by the machine learning model 125 and the labels determined based on inputs from the first group of reviewers 140 and/or the second group of reviewers 145 may increase, eventually eliminating the need for the labels determined by the machine learning model 125 to undergo further review.

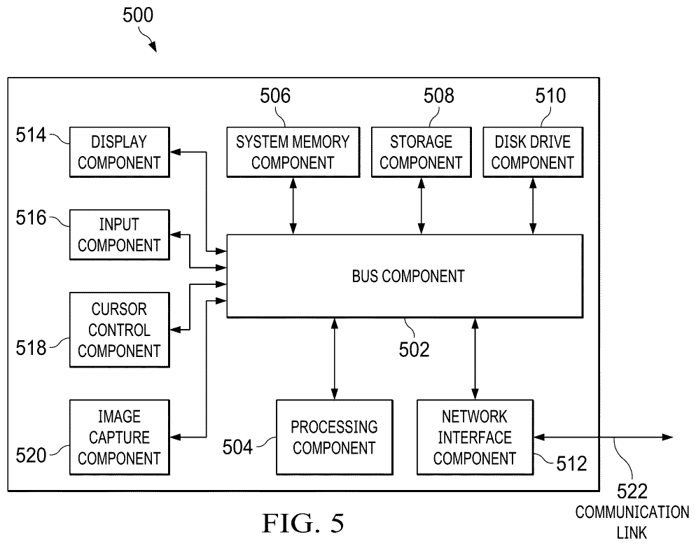

FIG. 5 is a block diagram of a computer system 500 suitable for implementing various methods and devices described herein, for example, the imaging system 105, the segmentation engine 120, the annotation controller 135, and/or the like. In various implementations, the devices capable of performing the steps may comprise imaging systems (e.g., cSLO imaging system, MRI imaging system, OCT imaging system, etc.), a network communications device (e.g., mobile cellular phone, laptop, personal computer, tablet, workstation, etc.), a network computing device (e.g., a network server, a computer processor, an electronic communications interface, etc.), or another suitable device. Accordingly, it should be appreciated that the devices capable of implementing the aforementioned servers and modules, and the various method steps of the process 400 discussed above, may be implemented as the computer system 500 in a manner as follows.

In accordance with various embodiments of the present disclosure, the computer system 500, such as a network server, a workstation, a computing device, a communications device, etc., includes a bus component 502 or other communication mechanisms for communicating information, which interconnects subsystems and components, such as a computer processing component 504 (e.g., processor, micro-controller, digital signal processor (DSP), etc.), system memory component 506 (e.g., RAM), static storage component 508 (e.g., ROM), disk drive component 510 (e.g., magnetic or optical), network interface component 512 (e.g., modem or Ethernet card), display component 514 (e.g., cathode ray tube (CRT) or liquid crystal display (LCD)), input component 516 (e.g., keyboard), cursor control component 518 (e.g., mouse or trackball), and image capture component 520 (e.g., analog or digital camera). In one implementation, disk drive component 510 may comprise a database having one or more disk drive components.

In accordance with embodiments of the present disclosure, computer system 500 performs specific operations by the processor 504 executing one or more sequences of one or more instructions contained in system memory component 506. Such instructions may be read into system memory component 506 from another computer readable medium, such as static storage component 508 or disk drive component 510. In other embodiments, hard-wired circuitry may be used in place of (or in combination with) software instructions to implement the present disclosure. In some example embodiments, the various components of the image capture device 110, image denoiser 115, the evaluator 160, the machine learning model 125, the interface 155, etc., may be in the form of software instructions that can be executed by the processor 504 to automatically perform context-appropriate tasks on behalf of a user.

Logic may be encoded in a computer readable medium, which may refer to any medium that participates in providing instructions to the processor 504 for execution. Such a medium may take many forms, including but not limited to, non-volatile media and volatile media. In one embodiment, the computer readable medium is non-transitory. In various implementations, non-volatile media includes optical or magnetic disks, such as disk drive component 510, and volatile media includes dynamic memory, such as system memory component 506. In one aspect, data and information related to execution instructions may be transmitted to computer system 500 via a transmission media, such as in the form of acoustic or light waves, including those generated during radio wave and infrared data communications. In various implementations, transmission media may include coaxial cables, copper wire, and fiber optics, including wires that comprise bus 502.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read. These computer readable media may also be used to store the programming code for the image capture device 110, image denoiser 115, the evaluator 160, the machine learning model 125, the interface 155, etc., discussed above.

In various embodiments of the present disclosure, execution of instruction sequences to practice the present disclosure may be performed by computer system 500. In various other embodiments of the present disclosure, a plurality of computer systems 500 coupled by communication link 522 (e.g., a communications network, such as a LAN, WLAN, PTSN, and/or various other wired or wireless networks, including telecommunications, mobile, and cellular phone networks) may perform instruction sequences to practice the present disclosure in coordination with one another.

Computer system 500 may transmit and receive messages, data, information and instructions, including one or more programs (i.e., application code) through communication link 522 and communication interface 512. Received program code may be executed by computer processor 504 as received and/or stored in disk drive component 510 or some other non-volatile storage component for execution. The communication link 522 and/or the communication interface 512 may be used to conduct electronic communications between the imaging system 105 and the segmentation engine 120, and/or between the segmentation engine 120 and the annotation controller 135, for example.

FIG. 6 depicts an example of an image 600 annotated with one or more segmentation labels in accordance with various embodiments of the present disclosure. In the example shown in FIG. 6, the image 600 may be an optical coherence tomography (OCT) scan depicting a cross section of the retina of an eye. Accordingly, the image 600 may be annotated with labels that identify, for each pixel within the image 600, one or more features of the retina to which the pixel belongs. For example, in some cases, annotating the image 600 may include identifying the boundaries around and/or between various retinal features. In the example show in FIG. 6, for instance, the image 600 may be annotated with a first boundary 610, a second boundary 620, and a third boundary 630 demarcating various layers of the retina depicted in the image 600. Doing so may segment the image 600 into various portions, each of which corresponding to a retinal structure (an inner limiting membrane (ILM), an external or outer plexiform layer (OPL), a retinal pigment epithelium (RPE), a Bruch's membrane (BM), and/or the like), abnormality, and/or morphological change (e.g., a drusen, a reticular pseudodrusen (RPD), a retinal hyperreflective foci, a hyporeflective wedge-shaped structure, a choroidal hypertransmission defect, and/or the like). FIG. 7A depicts a qualitative evaluation of medical image annotations performed by expert reviewers and non-expert reviewers (e.g., aggregated by applying a simultaneous truth and performance level estimation (STAPLE) algorithm). For example, the first image 700 shown in FIG. 7A compares the annotations made by different expert reviewers while the second image 750 shown in FIG. 7B compares the annotations made by different expert reviewers as well as an aggregate of the annotations made by non-expert reviewers. Meanwhile, FIG. 7B depicts a quantitative evaluation of the medical image annotations performed by expert reviewers and non-expert reviewers. The quantitative evaluation shown in FIG. 7B is based on a comparison of the consensus metric (e.g., the intersection over union (IOU)) of labels originating from within and across expert and non-expert groups of reviewers.

FIG. 8 depicts an example of a raw image 1010 (e.g., a raw optical coherence tomography (OCT) scan), a labeled image 1020 in which a hyperreflective foci (HRF) and a drusen are annotated, and an output 1030 of the machine learning model 125 trained, for example, based on the labeled image 1020. As shown in FIG. 8, the output 1030 indicates that the trained machine learning model 125 is capable of identifying regions (e.g., pixels) within the image 1010 corresponding to various retinal features such as hyperreflective foci (HRF), drusen, and/or the like. However, it should be appreciated that the trained machine learning model 125 performing image segmentation on the image 1010 may be capable of identifying a variety of features, such as retinal structures, abnormalities, and/or morphological changes in a retina depicted in the image 1010. For example, in some cases, in addition to the patient's age, at least some of the biomarkers for the predicting the progression of an eye disease in the patient, such as age-related macular degeneration (AMD) and nascent geographic atrophy (nGA), may be determined based on one or more retinal features.

FIG. 9 depicts several examples including drusen volume, maximum drusen height, hyperreflective foci (HRF) volume, minimum outer nuclear layer (ONL) thickness, and retinal pigment epithelium (RPE) volume. Table 1 below depicts a comparison of biomarkers derived from color fundus photography (CFP) images and biomarkers derived from optical coherence tomography (OCT) scans for predicting progression of nascent geographic atrophy (nGA) in patients.

TABLE 1

| | | AUC (95% CI) | p-value | Survival R² | p-value |
|---|---|---|---|---|---|
| CFP biomarkers | Age + Pigmentary | 0.80 | — | 0.49 | — |
| (Manual) | Abnormalities | (0.72 to 0.89) | | (0.38 to 0.61) | |
| OCT biomarkers | Age + HRF | 0.81 | 0.84 | 0.59 | 0.31 |
| (Auto) | Volume + Drusen | (0.73 to 0.89) | | (0.48 to 0.70) | |
| | volume | | | | |

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as computer program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein. It is understood that at least a portion of the image capture device 110, image denoiser 115, the evaluator 160, the machine learning model 125, the interface 155, etc., may be implemented as such software code.

### RECITATIONS OF SOME EMBODIMENTS OF THE PRESENT DISCLOSURE

Embodiment 1: A method, comprising: receiving an image of a sample having a feature; generating, using a neural network, an annotation representing the feature; generating, using the neural network, a labeled image comprising the annotation; prompting presentation of the labeled image to an image correction interface; receiving, from the image correction interface, label correction data related to the annotation generated by the first neural network; and updating the labeled image using the label correction data to generate an annotated image comprising an update to the labeled image.
Embodiment 2: The method of embodiment 1, wherein the update includes a confidence value for the annotation representing the feature.
Embodiment 3: The method of embodiment 2, further comprising: validating the annotation in the annotated image based on a comparison of the confidence value to a pre-set confidence threshold.
Embodiment 4: The method of any of embodiments 1 to 3, wherein the feature includes a biomarker that is indicative of age-related macular degeneration (AMD).
Embodiment 5: The method of any of embodiments 1 to 4, wherein the label correction data includes indications of affirmation, rejection, or modification of the label received at the image correction interface.
Embodiment 6: The method of embodiment 5, wherein the indications are input into the image correction interface by one or more trained users.
Embodiment 7: The method of any of embodiments 1 to 6, wherein the sample is a tissue sample or a blood sample.
Embodiment 8: The method of any of embodiments 1 to 7, further comprising training the neural network with the annotated image.
Embodiment 9: A system, comprising: a non-transitory memory; and a hardware processor coupled with the non-transitory memory and configured to read instructions from the non-transitory memory to cause the system to perform the method of any of embodiments 1-8.
Embodiment 10: A non-transitory computer-readable medium (CRM) having program code recorded thereon, the program code comprising code for causing a system to perform the method of any of embodiments 1-8.
Embodiment 11: A computer-implemented method, comprising: determining, based at least on a first input, a first set of labels for segmenting an image; updating, based at least on a second input, the first set of labels to generate a second set of labels for segmenting the image; generating, based at least on the first set of labels and/or the second set of labels, a set of ground truth labels for segmenting the image; generating a training sample to include the image and the set of ground truth labels for the image; and training, based at least on the training sample, a machine learning model to perform image segmentation.
Embodiment 12: The method of embodiment 11, further comprising: applying the machine learning model to generate a set of preliminary labels for segmenting the image; and updating, based at least on a third input, the set of preliminary labels to generate the first set of labels.
Embodiment 13: The method of any of embodiments 11 to 12, further comprising: combining the first set of labels to generate an aggregated label set; and generating, for display at one or more client devices, a user interface including the aggregated label set.
Embodiment 14: The method of embodiment 13, wherein a simultaneous truth and performance level estimation (STAPLE) algorithm is applied to combine the first set of labels.
Embodiment 15: The method of any of embodiments 13 to 14, wherein the first set of labels include a first label assigned to a pixel in the image by a first reviewer, a second label assigned to the pixel by a second reviewer, and a third label assigned to the pixel by a third reviewer.
Embodiment 16: The method of embodiment 15, wherein the aggregated label set includes, for the pixel in the image, a fourth label corresponding to a weighted combination of the first label, the second label, and the third label.
Embodiment 17: The method of embodiment 16, wherein the first label is associated with a first weight corresponding to a first accuracy of the first reviewer, the second label is associated with a second weight corresponding to a second accuracy of the second reviewer, and the third label is associated with a third weight corresponding to a third accuracy of the third reviewer.
Embodiment 18: The method of any of embodiments 16 to 17, wherein the second input confirms, refutes, and/or modifies the fourth label.
Embodiment 19: The method of any of embodiments 11 to 18, further comprising: determining a consensus metric indicative a level of discrepancy between a plurality of labels assigned to a same pixel in the image by different reviewers.
Embodiment 20: The method of embodiment 19, wherein the consensus metric comprises an intersection over union (IOU).
Embodiment 21: The method of any of embodiments 19 to 20, further comprising: upon determining that the consensus metric for the first set of labels fail to satisfy a threshold, escalating the first set of labels for review.
Embodiment 22: The method of any of embodiments 11 to 21, wherein the set of ground truth labels identifies one or more features present within the image.
Embodiment 23: The method of embodiment 22, wherein the set of ground truth labels includes, for each pixel within the image, a label identifying the pixel as belonging to a feature of the one or more features present within the image.
Embodiment 24: The method of any of embodiments 22 to 23, wherein the one or more features include one or more structures, abnormalities, and/or morphological changes present in a retina depicted in the image.
Embodiment 25: The method of any of embodiments 22 to 24, wherein the one or more features comprise biomarkers for a disease.
Embodiment 26: The method of any of embodiments 22 to 25, wherein the one or more features comprises biomarkers for predicting a progression of nascent geographic atrophy (nGA) and/or age-related macular degeneration (AMD).
Embodiment 27: The method of any of embodiments 22 to 26, wherein the one or more features include drusen volume, maximum drusen height, hyperreflective foci (HRF) volume, minimum outer nuclear layer (ONL) thickness, and retinal pigment epithelium (RPE) volume.
Embodiment 28: The method of any of embodiments 11 to 27, wherein the machine learning model comprises a neural network
Embodiment 29: The method of any of embodiments 11 to 28, wherein the image comprise one or more of a computed tomography (CT) image, an optical coherence tomography (OCT) scan, an X-ray image, a magnetic resonance imaging (MRI) scan, and an ultrasound image.
Embodiment 30: The method of any of embodiments 11 to 29, wherein the first input is associated with a first group of reviewers and the second input is associated with a second group of reviewers.
Embodiment 31: A system, comprising: at least one data processor, and at least one memory storing instructions, which when executed by the at least one data processor, result in operations comprising the method of any of embodiments 11 to 30.
Embodiment 32: A non-transitory computer readable medium storing instructions, which when executed by at least one data processor, result in operations comprising the method of any of embodiments 11 to 30.

While the present teachings are described in conjunction with various embodiments, it is not intended that the present teachings be limited to such embodiments. On the contrary, the present teachings encompass various alternatives, modifications, and equivalents, as will be appreciated by those of skill in the art.

In describing the various embodiments, the specification may have presented a method and/or process as a particular sequence of steps. However, to the extent that the method or process does not rely on the particular order of steps set forth herein, the method or process should not be limited to the particular sequence of steps described, and one skilled in the art can readily appreciate that the sequences may be varied and still remain within the spirit and scope of the various embodiments.

1. A method, comprising:
receiving an image of a sample having a feature;
generating, using a neural network, an annotation representing the feature;
generating, using the neural network, a labeled image comprising the annotation;
prompting presentation of the labeled image to an image correction interface;
receiving, from the image correction interface, label correction data related to the annotation generated by the first neural network; and
updating the labeled image using the label correction data to generate an annotated image comprising an update to the labeled image.

2. The method of claim 1, wherein the update includes a confidence value for the annotation representing the feature.

3. The method of claim 2, further comprising:
validating the annotation in the annotated image based on a comparison of the confidence value to a pre-set confidence threshold.

4. The method of claim 1, wherein the feature includes a biomarker that is indicative of age-related macular degeneration (AMD).

5. The method of claim 1, wherein the label correction data includes indications of affirmation, rejection, or modification of the label received at the image correction interface.

6. The method of claim 5, wherein the indications are input into the image correction interface by one or more trained users.

7. The method of claim 1, wherein the sample is a tissue sample or a blood sample.

8. The method of claim 1, further comprising training the neural network with the annotated image.

9. A system, comprising:
a non-transitory memory; and
a hardware processor coupled with the non-transitory memory and configured to read instructions from the non-transitory memory to cause the system to perform operations comprising:
receive an image of a sample having a feature;
generate, using a neural network, an annotation representing the feature;
generate, using the neural network, a labeled image comprising the annotation;
prompt presentation of the labeled image to an image correction interface;
receive, from the image correction interface, label correction data related to the annotation generated by the first neural network; and
update the labeled image using the label correction data to generate an annotated image comprising an update to the labeled image.

10. The system of claim 9, wherein the update includes a confidence value for the annotation representing the feature.

11. The system of claim 9, wherein the feature includes a biomarker that is indicative of age-related macular degeneration (AMD).

12. The system of claim 9, wherein the label correction data includes indications of affirmation, rejection, or modification of the label received at the image correction interface.

13. The system of claim 12, wherein the indications are input into the image correction interface by one or more trained users.

14. The system of claim 9, further comprising training the neural network with the annotated image.

15. A non-transitory computer-readable medium (CRM) having stored thereon computer-readable instructions executable to cause a computer system to perform operations comprising:
receiving an image of a sample having a feature;
generating, using a neural network, an annotation representing the feature;
generating, using the neural network, a labeled image comprising the annotation;
prompting presentation of the labeled image to an image correction interface;
receiving, from the image correction interface, label correction data related to the annotation generated by the first neural network; and
updating the labeled image using the label correction data to generate an annotated image comprising an update to the labeled image.

16. The non-transitory CRM of claim 15, wherein the update includes a confidence value for the annotation representing the feature.

17. The non-transitory CRM of claim 15, further comprising:
validating the annotation in the annotated image based on a comparison of the confidence value to a pre-set confidence threshold.

18. The non-transitory CRM of claim 15, wherein the feature includes a biomarker that is indicative of age-related macular degeneration (AMD).

19. The non-transitory CRM of claim 15, wherein the label correction data includes indications of affirmation, rejection, or modification of the label received at the image correction interface.

20. The non-transitory CRM of claim 15, wherein the sample is a tissue sample or a blood sample.

21-62. (canceled)
